(19) United States
(12) Patent Application Publication
(10) Pub. No.: US 2025/0155068 A1
(43) Pub. Date: May 15, 2025

(54) COMMUNICATING STRUCTURE AND COMMMUNICTAING METHOD THEREOF

(71) Applicant: TING-JUI WANG, New Taipei City (TW)

(72) Inventor: TING-JUI WANG, New Taipei City (TW)

(21) Appl. No.: 18/919,465

(22) Filed: Oct. 18, 2024

(30) Foreign Application Priority Data
Nov. 9, 2023 (TW) 112143268
Feb. 1, 2024 (TW) 113104018
May 22, 2024 (TW) 113118970

(51) Int. Cl. F16L 55/07

(52) U.S. Cl. CPC F16L 55/07

(57) ABSTRACT

The present disclosure provides a communicating structure including a first body and a second body, and a communicating method thereof. The first body includes a first flow path, a first block body and a communicating portion. The second body includes a second flow path and a second block body. The first block body can be rotated, turned, moved laterally or moved to communicate the communicating portion with the first flow path, for a fluid to flow through the first flow path and the communicating portion to push the second block body, and for the second block body to open the second flow path for the fluid to flow in the first flow path and the second flow path. Thus, a required fluid is enabled to flow stably in the first body and the second body.

### CROSS-REFERENCE TO RELATED APPLICATION

This non-provisional application claims priority under 35 U.S.C. § 119 (a) on Patent Application No(s). 112143268 filed in Taiwan, R.O.C. on Nov. 9, 2023, and Patent Application No(s). 113104018 filed in Taiwan, R.O.C. on Feb. 1, 2024, and Patent Application No(s). 113118970 filed in Taiwan, R.O.C. on May 22, 2024, the entire contents of which are hereby incorporated by reference.

### BACKGROUND OF THE INVENTION

### 1. Field of the Invention

The present disclosure provides a fluid communicating structure and a communicating method thereof, and in particular to a communicating structure enabling a required fluid to flow stably.

### 2. Description of the Related Art

In common fluid transportation, a valve is provided according to a pipeline of the fluid, so as to serve as a switch for the fluid transportation.

However, a gap is usually caused in such conventional valve after use for an extended period of time, resulting in loss of the function of the valve and hence failure of stable transportation of the fluid in the pipeline.

### BRIEF SUMMARY OF THE INVENTION

In view of the prior art above, the applicant has developed a communicating structure in the aim of achieving an object of enabling a required fluid to flow stably.

To achieve the above and other objects, the present disclosure provides a communicating structure including a first body and a second body. The first body includes a first flow path, which is movably provided with a first block body. The second body includes a second flow path, which is movably provided with a second block body. The first block body can be rotated, turned, moved laterally or moved for a fluid to flow through the first flow path and push the second block body so as to open the second flow path.

The present disclosure provides another communicating structure including a first body and a second body. The first body includes a first flow path which is movably provided with a first block body, and the first block body is provided with a communicating portion. The second body includes a second flow path which is movably provided with a second block body. The first block body can be rotated, turned, moved laterally or moved to communicate the communicating portion and the first flow path with each other, for a fluid to flow through the first flow path and the communicating portion to push the second block body, and for the second block body to open the second flow path for the fluid to flow in the first flow path and the second flow path.

The present disclosure provides another communicating structure including a first body and a second body. The first body includes a first flow path which is movably provided with a first block body, and the first block body is provided with a communicating portion. The second body includes a second flow path which is movably provided with a second block body. The first block body and the second block body can be rotated, turned, moved laterally or moved to communicate the first flow path, the communicating portion and the second flow path with each other, for the fluid to flow in the first flow path and the second flow path.

The present disclosure provides another communicating structure including a first body and a second body. The first body includes a first flow path, which is provided with a first block body. The second body includes a second flow path, which includes a second block body. The first block body and the second block body are moved to open a flow path for a fluid to flow in the first flow path and the second flow path.

The present disclosure provides another communicating structure including a first body and a second body. The first body includes a first flow path, which is movably provided with a first block body. The second body includes a second flow path, which includes a second block body. The first block body and the second block body are rotating bodies. The first block body is provided with a first dentate portion, the second block body is provided with a second dentate portion, and the first body or the second body is provided with a driving body, or an object is provided with a driving body for driving the first block body and the second block body to rotate so as to open a flow path.

The present disclosure provides another communicating structure including a first flow path and a second flow path. The first flow path is provided with a first block body, the second flow path is provided with a second block body, and the first block body or the second block body can be rotated, turned, moved laterally or moved to communicate the first flow path and the second flow path.

The present disclosure provides another communicating structure including a first body and a second body. The first body includes a first flow path, which is provided with a first block body. The second body includes a second flow path, which includes a second block body. The first block body or the second block body is moved to open the first flow path and the second flow path.

The present disclosure provides another communicating structure including a first body and a second body. The first body includes a first flow path, which is provided with a first block body. The second body includes a second flow path, which is provided with a second block body. The first block body and the second block body are rotating bodies. The first block body is provided with a first dentate portion or a driving body, and the second block body is provided with a second dentate portion or a driving body for driving, driving mutually, driving relatively, compelling, compelling mutually, compelling relatively, moving, moving mutually, moving relatively, operating, operating mutually, turning or turning relatively so as to open the first flow path and the second flow path.

The present disclosure provides another communicating structure including a first body and a second body. The first body includes a first flow path, which is provided with a first block body. The second body includes a second flow path, which is provided with a second block body. The first block body and the second block body are rotating bodies, the first block body is provided with a first dentate portion or a driving body, and the second block body is provided with a second dentate portion or a driving body.

The present disclosure provides another communicating structure including a first body and a second body. The first body includes a first flow path, which is provided with a first block body. The second body includes a second flow path, which is provided with a second block body. The first block body is provided with a first dentate portion or a driving body, and the second block body is provided with a second dentate portion or a driving body.

The present disclosure provides another communicating structure including a first body and a second body. The first body includes a first flow path, which is provided with a first block body. The second body includes a second flow path, which is provided with a second block body.

The present disclosure provides another communicating structure including a first body and a second body. The first body includes a first flow path, which is provided with a first block body. The second body includes a second flow path, which is provided with a second block body. The second body pushes the first block body to open the first flow path, for a fluid to push the second block body to open the second flow path, or the second body pushes the first block body to open the first flow path, for a fluid to flow into the second body to push the second block body, or wherein the second body presses the first block body to open the first flow path closed by a resist portion and the first block body, for a fluid to push the second block body so as to open the second flow path.

The present disclosure provides another communicating structure including a first body and a second body. The first flow path provided with a first block body, and the second flow path is provided with a second block body.

The present disclosure provides another communicating structure including a first body or a second body. The first body includes a first flow path which is provided with a first block body, or the second body includes a second flow path which is provided with a second block body.

The present disclosure provides another communicating method. The first block body is first rotated, turned, moved laterally or moved to open the first flow path, and then the second block body is moved laterally or moved to open the second flow path so as to communicate the first flow path and the second flow path, or the first block body is first moved laterally or moved to open the first flow path, and then the second block body is rotated, turned, moved laterally or moved to open the second path so as to communicate the first flow path and the second flow path, or the first block body is rotated, turned, moved laterally or moved to open the first flow path, and the second block body is also rotated, turned, moved laterally or moved to open the second flow path so as to communicate the first flow path and the second flow path.

The present disclosure provides another communicating method. The engaging body engages the first body and the second body, the first block body is first rotated, turned, moved laterally or moved to open the first flow path, and then the second block body is moved laterally or moved to open the second flow path so as to communicate the first flow path and the second flow path, or the engaging body engages the first body and the second body, the first block body is first moved laterally or moved to open the first flow path, and then the second block body is rotated, turned, moved laterally or moved to open the second path so as to communicate the first flow path and the second flow path.

The present disclosure provides another communicating method. The first block body is first rotated, turned, moved laterally or moved to open the first flow path, and the second block body pressed by the elastic element is pushed by a dynamic force or a thrust force of a fluid to communicate the first flow path and the second flow path, wherein the dynamic force or the thrust force of the fluid is greater than an elastic force of the elastic element.

In one embodiment, the first block body or the second block body is a ball valve, a lateral valve, a door valve or a valve, or the first block body is provided with a first operating portion or the second block body is provided with a second operating portion.

In one embodiment, the first operating portion or the second operating portion drives the first block body or the second block body to communicate the first flow path and the second flow path with each other.

In one embodiment, the first block body or the second block body is provided with a stop portion. The stop portion limits a movement position of the first block body, the second block body, the first operating portion or the second operating portion, and the stop portion is provided with at least one flow passage which is in communication with the second flow path or the first flow path.

In one embodiment, the first body, the first flow path, the first block body, the second body, the second flow path or the second block body is provided with a fluid block body or a fluid absorption body.

In one embodiment, the first block body, the second block body, the fluid block body or the fluid absorption body is a corresponding structure, for the first block body and the second block body to come into contact with, block against or elastically block against each other in between.

In one embodiment, corresponding parts of the first block body and the second block body are arcs, slopes, steps, planes, curves, recesses or protrusions.

In one embodiment, the first block body and the second block body are corresponding structures, for a fluid storage space between the first block body and the second block body to be less than 500 c.c., or the first operating portion or the second operating portion is a rod, a recess, a protrusion, a shaft portion or a shaft.

In one embodiment, the fluid block body or the fluid absorption body is an O-ring, a ring, an elastic body, foam, a cotton body, a suction fluid valve, a sponge body, a siphon, a foam body, a fiber body, a suction cotton body, a recyclable material body, a decomposable material body, a glue body, a buffer body or a fluid absorbing object.

In one embodiment, the first body or the second body is provided with an engaging body. The engaging body engages the first body and the second body, and is an elastic engaging body, a bead, a plastic fastener, a metal engaging body, a labor-saving engaging body, a spring engaging body, or a lever engaging body, or the engaging body engages the first body and the second body.

In one embodiment of the present disclosure, the first body is provided with an elastic element, and two ends of the elastic element respectively press against the first body and the first block body.

In one embodiment of the present disclosure, the second body is provided with an elastic element, and two ends of the elastic element respectively press against the second body and the second block body.

In one embodiment of the present disclosure, the second body is provided with an elastic element, two ends of the elastic element respectively press against the second body and the second block body, an elastic force of the elastic element is less than a dynamic force or a thrust force of a fluid flowing to the second flow path, or an elastic force of the elastic element is less than a dynamic force or a thrust force of a fluid flowing from the first body to the second flow path.

In one embodiment, the second body has a limiting power or a limiting structure for limiting the second block body, or the limiting power or a force of the limiting structure is less than a dynamic force or a thrust force of a fluid flowing from the first body to the second flow path and is for pushing the second block body to open the second flow path, or the limiting force or the limiting structure is an elastic force, an elastic structure, a structure capable of reciprocating motion, a force capable of reciprocating motion, a fluid force, a gas force or electrically driven force.

In one embodiment, the communicating structure is installed at a data center, a server, a storage device, an electronic device, a mechanical device, a liquid cooling device, an engineering device or a computer, or the first flow path and the second flow path of the communicating structure are for flowing through a heat generator or a heat dissipater so as to perform heat dissipation, or wherein the first body or the second body is fixed at an object, and the object is a cabinet, a frame, a casing, a data center, a computer, a server, a storage device, a heat dissipater, a heat sink, a metal body or a plastic body, or the first body and the second body are coupled in a fixed manner, a linear manner, an aligned manner, a floating manner, a blind manner or a positioned manner, or wherein the fluid is a water cooling liquid, a liquid, a gas, water or oil.

In one embodiment, the first flow path, the communicating portion or the second flow path is groove-shaped, hole-shaped or tubular-shaped.

In one embodiment, the first flow path or the second flow path is groove-shaped, hole-shaped or tubular-shaped.

In one embodiment, the fluid is a water cooling liquid, a liquid, a gas, water or oil.

In one embodiment, a pressure apparatus is further included. The pressure apparatus is in communication with the first flow path or the second flow path, and is for a fluid in the first flow path or the second flow path to have a thrust force.

In one embodiment, the first body, the first block body, the second body or the second block body has a sloped surface, a curved surface, an arc surface or a diversion structure to facilitate a fluid to flow or be discharged.

In one embodiment, the second block body or the first block body has a discharge portion for discharging a fluid between the first body and the second body, or for discharging a fluid between the first block body and the second block body.

In one embodiment, the discharge portion is a hole, a tapered hole, a dilating hole, a groove, a notch, a piston, a plug, an object for one-way discharge of a fluid, an object for restricting one-way discharge of a fluid, a fluid absorption body, a soft body, a hard body, a one-way valve, a rubber body, a silicone body, a check body, a stop check body, a non-return valve, a stop check valve, a leakproof body, a structure with incision, a structure with an opening, a structure with a unidirectional incision, a structure with an unidirectional opening, a metal body or a plastic body.

In one embodiment, the first body, the first block body, the second body, the second block body, an object linked with the first body or an object linked with the second body is provided with a gear or a rack, and the gear or the rack coordinate with each other to rotate, turn, move laterally, or move the first block body to communicate the first flow path and the second flow path.

In one embodiment, the first body is provided with a push portion, which pushes the second block body in the second body.

In one embodiment, the push portion has a channel, a fluid is communicated via the channel when the push portion enters the second body, and the channel is located on a lateral position of the push portion.

In one embodiment, the first body or the second body is fixed at an object, and the object is a cabinet, a frame, a casing, a data center, a computer, a server, a storage device, a heat dissipater, a heat sink, a metal body or a plastic body, for the first body and the second body to be coupled in a fixed manner, a linear manner, a floating manner, an aligned manner, a blind manner or a positioned manner.

In one embodiment, the object and the first body, the second body, a flow path or a flow passage have a floating space in between, and the floating space is for the first body and the second body to be coupled in a fixed manner, a linear manner, a floating manner, an aligned manner, a blind manner or a positioned manner.

In one embodiment, the first block body and the second block body are rotating bodies, the first block body is provided with a first dentate portion, the second block body is provided with a second dentate portion, the first body or the second body is provided with a driving body, and the driving body drives the first dentate portion and the second dentate portion, so as to drive the first block body and the second block body to respectively open the first flow path and the second flow path.

In one embodiment, the first block body and the second block body are rotating bodies, the first block body is provided with a first dentate portion, the second block body is provided with a second dentate portion, the first body or the second body is provided with a driving body, and the first dentate portion, the driving body and the second dentate portion drive each other, so as to open the first flow path and the second flow path.

In one embodiment, each of the first dentate portion, the second dentate portion and the driving body is a gear, rack, a lever structure or a push structure.

In one embodiment, an elastic element is further included, and two ends of the elastic element respectively press against the engaging portion and the first body or the second body.

In one embodiment, the first block body is provided with a first operating portion or the second block body is provided with a second operating portion, or the first operating portion has a first positioning portion or the second operating portion has a second positioning portion, or the first block body has a first positioning portion or the second block body has a second positioning position, or the first body has a first positioning portion or the second body has a second positioning portion, or the first positioning portion or the second positioning portion is for positioning the first block body or the second block body at a position at which a flow path is open or at a position at which a flow path is closed.

In one embodiment, an elastic element is further included. The elastic element is for the first positioning portion or the second positioning portion to be elastically engagingly connected at the first body or the second body, for the first block body or the second block body to be limited at a position at which a flow path is open or at a position at which a flow path is closed, or the first positioning portion or the second positioning portion is an engaging body, an engaging portion or a limiting portion.

In one embodiment, the first block body or the second block body is installed with, interferes with, has, in contact with, or is adjacent to a fluid block body or a fluid absorption body, or wherein the first block body or the second block body is a fluid block body or a fluid absorption body, or wherein a fluid block body or a fluid absorption body can absorb a fluid of the first block body or the second block body or between two block bodies.

In one embodiment, the first block body, the second block body, the first body or the second body has a fluid absorption body, wherein a position of the fluid absorption body does not come into contact with a fluid when the fluid flows, and when one of the first block body and the second block body is closed, or when both of the first block body and the second block body are closed, or when the first body and the second body are separated, is for the fluid absorption body to absorb a fluid not closed by the first block body or the second block body, or a fluid residing between the first block body, the second block body or the first body or the second body.

In one embodiment, the first block body or the second block body is installed with, interferes with, has, in contact with, or is adjacent to a fluid block body or a fluid absorption body, or wherein the first block body or the second block body is a fluid block body or a fluid absorbing body, wherein a part of a fluid block body or a fluid absorption body corresponding with any object is an arc, a slope, a step, a plane, a curve, a recess, a protrusion, or a structure capable of fitting with, interfering with or getting close to any object.

In one embodiment, the first block body is connected to a first dentate portion, the second block body is connected to a second dentate portion, the first dentate portion is turned to drive the second dentate portion to open or close two flow paths, the first block body or the second block body is a valve, a ball valve, a lateral valve, a door valve or a valve body, and the first dentate portion or the second dentate portion is a gear or a rack.

In one embodiment, the first body or the second body is installed at an object, the object is a casing, a cabinet, a metal body, a plastic body or a printed circuit board, the first body, the second body and the object have a floating space in between, and the floating space is for correcting or guiding coupling of the first body, the first flow path, the second body or the second flow path.

In one embodiment, the second body is provided with at least a track, which is for guiding or regularizing the second block body.

In one embodiment, the second body is provided with a resist portion, the resist portion limits a receding position of the second block body and is provided with at least one through hole, and the through holes is in communication with the second flow path.

In one embodiment, the second body pushes the first block body to open the first flow path closed by a resist portion and the first block body, for the fluid to push the second block so as to open the second flow path.

In one embodiment, the second body pushes the first block body to open the first flow path closed by a resist portion and the first block body, and the resist portion is for moving the second block body in a direction for opening the second flow path, for the fluid to push the second block so as to open the second flow path.

In one embodiment, the second body pushes the first block body to open the first flow path closed by a resist portion and the first block body, and the resist portion pushes the second block body to open the second flow path.

In one embodiment, the first body is provided with a resist portion, and the resist portion has at least one circulation portion to communicate a fluid, or for the second body to press the first block body to open the first flow path for the fluid to flow into the second body through the circulation portion, or for the second body to push the first block body to open the first flow path and for the resist portion to push the second body for the fluid to flow into the second body.

In one embodiment, the second body pushes the first block body to open the first flow path closed by a resist portion and the first block body, for a fluid to push the second block body to open the second flow path, wherein an elastic element is included to press against the second body and the second block body, for opening the second flow path when a force of the fluid is greater than a force of the elastic element, the force of the fluid is reduced when the second body moves in a direction for closing the first flow path, the flow path is closed when the force of the elastic element is greater than the force of the fluid, or the force of the fluid is reduced or the force of the fluid is stopped when the second body moves in a direction for closing the first flow path, and when the force of the elastic element is greater than the force of the fluid or when the force of the fluid is stopped, the second flow path is closed or the first flow path is closed, or the first flow path and the second flow path are simultaneously closed, or the first flow path is first closed and then the second flow path is closed, or the second flow path is first closed and then the first flow path is closed, or a direction in which the second body moves in a direction for closing the first flow path is moving toward the second body.

In one embodiment, the first body or the second body is installed at an object, which drives or is linked with the first body or the second body to insert into, assemble into, insert into in a blind manner, or couple with in a blind manner the second body or the first body, or wherein an object is a printed circuit board (PCB), a heat dissipater, a casing, an integrated circuit (IC), a computer, an electrical conductor, a metal body, a non-metal body or a plastic body.

In one embodiment, the first body or the second body has an operating portion, which has an engaging portion for engagingly connecting at the second body or the first body, or the engaging portion has a pull portion, or for the pull portion to be pressed or pulled to close the engaging portion, or the engaging portion has an elastic element for elastic engagement connection of the engaging portion.

In one embodiment, the second body has a driving portion. The driving portion is for driving the first block body, or the driving portion is for driving the first block body to rotate or turn to open the first flow path, or wherein the driving portion is a dentate portion, a gear or a rack, or wherein the driving portion laterally or vertically drives a driving portion of the first body, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

In one embodiment, the first body has a driving portion. The driving portion is for driving the second block body, or the driving portion is for driving the second block body to rotate or turn to open the second flow path, or wherein the driving portion is a dentate portion, a gear or a rack, or wherein the driving portion laterally or vertically drives a driving portion of the second body, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

In one embodiment, the second body or the first body has a driving portion. The driving portion is for driving the second block body and the first block body, or the driving portion is for driving the second block body or the first block body to rotate or turn to open the first flow path or the second flow path, or wherein the driving portion is a dentate portion, a gear or a rack, or wherein the driving portion drives laterally or vertically, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

In one embodiment, the second body or the first body has a driving portion. The driving portion is for first driving one of the second block body or the first block body, and then driving one of the second block body or the first block body, for the second block body or the first block body to have different opening/closing sequences, or for the first block body or the second block body to be not closed when the second block body or the first block body is closed, or for a fluid to flow to the second block body or the first block body that is not closed, or for a fluid between the second block body or the first block body to flow into the first block body or the second block body that is not closed, or to close the first block body or the second block body when there is no fluid or when there is almost no fluid between the second block body or the first block body.

In one embodiment, the first flow path, the second flow path or the communicating portion and another communicating portion are located at different heights, height differences, up and down positions or up and down position differences, or for a fluid to flow from a high position to a low position so that the fluid flows to a low position when the first block body or the second block body that is at a higher position is closed, or to reduce or completely block a fluid between the first block body and the second block body when both of the first block body and the second block body are closed.

In one embodiment, the first block body or the second block body has a torsion spring or an elastic element, and the torsion spring or the elastic element has one end press against the first body or the second body and the other end press against the first block body or the second block body, for the first block body or the second block body that is rotatable or turnable to normally press against a position at which the first flow path or the second flow path is closed, or for the first block body or the second block to normally press against a position at which the first flow path or the second flow path is open.

In one embodiment, the communicating structure is installed at a heat dissipater, or the heat dissipater is in contact with a heat generator for heat dissipation, or the heat generator is disposed in two heat dissipaters for heat dissipation, or the heat generator is disposed in one heat dissipater for heat dissipation, or wherein one heat dissipater is disposed with the communicating structure, or wherein two heat dissipaters are disposed with the communicating structure, or the heat dissipater is installed at an object, or the object is a printed circuit board, a metal body, a plastic body, a heat dissipater, a computer component, a casing component, a server component or a server casing, or the heat generator is a chip, a central process unit (CPU) or a graphics processing unit (GPU).

In one embodiment, the second block body and the second body or the first body have a flow space in between, for a fluid located between the first block body and the second block body to flow from the flow space or flow into the second body when the second body is closed, or for a fluid located between the first body and the second body to flow from the flow space or flow into the second body when the second body is closed, or the second block body has a fluid block body, or the second block body has a fluid block body at a position capable of delaying or later closing the flow space, or for closing inflow or outflow of a fluid in the flow space after the fluid passes through the flow space, or for closing the flow space, or for reducing or decreasing a fluid between the first block body and the second block body, or for reducing or decreasing a fluid between the first body and the second body.

The present disclosure further provides another communicating method. The first block body and the second block body are rotating bodies, the first block body is provided with a first dentate portion, the second block body is provided with a second dentate portion, the first body or the second body is provided with a driving body, and the driving body drives the first dentate portion and the second dentate portion, so as open the first flow path and the second flow path.

The present disclosure further provides another communicating method. The first block body and the second block body are rotating bodies, the first block body is provided with a first dentate portion, the second block body is provided with a second dentate portion, the first body or the second body is provided with a driving body, and the first dentate portion, the driving body and the second dentate portion drive each other, so as to open the first flow path and the second flow path.

The present disclosure further provides another communicating method. The first block body and the second block body are rotating bodies, the first block body is provided with a first dentate portion, the second block body is provided with a second dentate portion, and the first body or the second body is provided with a driving body, or an object is provided with a driving body, or wherein the first dentate portion, the second dentate portion or the driving body is a gear, a rack, a lever structure or a push structure, or the first dentate portion, the driving body and the second dentate portion drive each other to open the first flow path and the second flow path, or the driving body drives the first dentate portion and the second dentate portion to open the first flow path and the second flow path.

The present disclosure provides another communicating method of a communicating structure. The communicating structure includes a first body and a second body; the first body includes a first flow path which is movably provided with a first block body, and the second body includes a second flow path which is movably provided with a second block body. The first block body is moved to open the first flow path, and then the second block body is moved laterally or moved to open the second flow path so as to communicate the first flow path and the second flow path, or the first block body is first moved laterally or moved to open the first flow path, and then the second block body is rotated or moved to open the second flow path so as to communicate the first flow path and the second flow path, or the first block body moved to open the first flow path, and the second block body moved to open the second flow path so as to communicate the first flow path and the second flow path.

The present disclosure provides another communicating method of a communicating structure. The communicating structure includes a first body and a second body; the first body includes a first flow path which is movably provided with a first block body, and the second body includes a second flow path which is movably provided with a second block body. The first block body is moved to open the first flow path, and the second block body pressed by an elastic element is pushed by a dynamic force or a thrust force of a fluid so as to communicate the first flow path and the second flow path, or the first block body is moved to open the first flow path, and the second block body is pushed by a dynamic force or a thrust force of a fluid so as to communicate the first flow path and the second flow path.

The present disclosure provides another communicating method of a communicating structure. The communicating structure includes a first body and a second body; the first body includes a first flow path which is movably provided with a first block body, and the second body includes a second flow path which is movably provided with a second block body. The first block body and the second block body are rotating bodies, the first block body is provided with a first dentate portion, the second block body is provided with a second dentate portion, the first body or the second body is provided with a driving body, and the driving body drives the first dentate portion and the second dentate portion to open the first flow path and the second flow path, or the first dentate portion, the driving body and the second dentate portion drive each other to open the first flow path and the second flow path, or the second dentate portion drives the driving body to drive the first dentate portion to open the first flow path and the second flow path, or the first dentate portion drives the driving body to drive the second dentate portion to open the first flow path and the second flow path.

The present disclosure provides another communicating method of a communicating structure. The communicating structure includes a first body and a second body; the first body includes a first flow path which is movably provided with a first block body, and the second body includes a second flow path which is movably provided with a second block body. The first block body and the second block body are rotating bodies, the first block body is provided with a first dentate portion, the second block body is provided with a second dentate portion, and the first body or the second body is provided with a driving body, or an object is provided with a driving body, or wherein the first dentate portion, the second dentate portion or the driving body is a gear, a rack, a lever structure or a push structure, or the first dentate portion, the driving body and the second dentate portion drive each other to open the first flow path and the second flow path, or the driving body drives the first dentate portion and the second dentate portion to open the first flow path and the second flow path, or the second dentate portion drives the driving body to drive the first dentate portion to open the first flow path and the second flow path, or the first dentate portion drives the driving body to drive the second dentate portion to open the first flow path and the second flow path.

The present disclosure further provides another communicating method of a communicating structure. The communicating structure communicates a fluid to flow through a heat dissipater, a heat dissipation structure or a heat dissipation system for heat dissipation, or the heat dissipater or the heat dissipation system guides heat generated from energizing a chip, an IC, a CPU, GPU, a battery, a power storage device or a memory to reduce a temperature, or the first flow path, the second flow path, the first block body or the second block body is for being assembled, removed or opened/closed to communicate the fluid, or the fluid block body or the fluid absorption body is for absorbing a fluid of the first flow path, the second flow path, the first block body or the second block body or between two block bodies, or the fluid block body or the fluid absorption body is for absorbing a fluid of the first flow path, the second flow path, the first block body or the second block body or between two block bodies that are closed, or for preventing a fluid from flowing to a chip or a circuit board, or for preventing a fluid from flowing to a chip or a circuit board and hence from causing short circuitry or contamination, or the first flow path or the second flow path of the communicating structure is a heat dissipater, a heat dissipation structure or a heat dissipation system.

The present disclosure further provides another communicating method of a communicating structure. The second body is provided with an elastic element, two ends of the elastic element respectively press against the second body and the second block body, or an elastic force of the elastic element is less than a dynamic force or a thrust force of a fluid flowing to the second flow path, or an elastic force of the elastic element is less than a dynamic force or a thrust force of a fluid flowing from the first body to the second flow path, or an elastic force of the elastic element is less than a dynamic force or a thrust force of a fluid flowing from the first body to the second body, so as to push the second block body to open the second flow path.

The present disclosure further provides another communicating method of a communicating structure. The second body has a limiting power or a limiting structure for limiting the second block body, or the limiting power or a force of the limiting structure is less than a dynamic force or a thrust force of a fluid flowing from the first body to the second flow path and is for pushing the second block body to open the second flow path, or the limiting force or the limiting structure is an elastic force, an elastic structure, a structure capable of reciprocating motion, a force capable of reciprocating motion, a fluid force, a gas force or electrically driven force.

The present disclosure further provides another communicating method of a communicating structure. The first block body or the second block body is installed with, interferes with, has, in contact with or is adjacent to a fluid block body or a fluid absorption body, or wherein the first block body or the second block body is the fluid block body or the fluid absorption body, or wherein the fluid block body or the fluid absorption body can absorb a fluid of the first block body or the second block body or between two block bodies, or the first block body and the second block body are rotated to close a flow path for the fluid block body or the fluid absorption body to absorb a fluid of the first block body or the second block body or between two block bodies, or the first block body is rotated to close a flow path and the second block body is moved laterally to close a flow path for the fluid block body or the fluid absorption body to absorb a fluid of the first block body or the second block body or between two block bodies, or the first block body is rotated to close a flow path or the second block body is moved laterally to close a flow path for the fluid block body or the fluid absorption body to absorb a fluid of the first block body or the second block body or between two block bodies, or the first block body, the second block body, the first body or the second body has a fluid absorption body, wherein a position of the fluid absorption body does not come into contact with a fluid when the fluid flows, and when one of the first block body and the second block body is closed, or when both of the first block body and the second block body are closed, or when the first body and the second body are separated, for the fluid absorption body to absorb a fluid not closed by the first block body or the second block body, or a fluid residing between the first block body, the second block body or the first body or the second body.

The present disclosure further provides another communicating method of a communicating structure. The communicating structure is installed at a data center, a server, a storage device, an electronic device, a mechanical device, a liquid cooling device, an engineering device or a computer, or the first flow path or the second flow path of the communicating structure is for flowing through a heat generator or a heat dissipater so as to perform heat dissipation, or wherein the first body or the second body is fixed at an object, the object is a cabinet, a frame, a casing, a data center, a computer, a server, a storage device, a heat dissipater, a heat sink, a metal body or a plastic body, or the first body and the second body are coupled in a fixed manner, a linear manner, an aligned manner, a floating manner, a blind manner or a positioned manner, or wherein the fluid is a water cooling liquid, a liquid, a gas, water or oil, or wherein the object and the first body, the second body, a flow path or a flow passage have a floating space in between, the floating space is for the first body and the second body to be coupled in a fixed manner, a linear manner, a floating manner, an aligned manner, a blind manner or a positioned manner, or wherein a pressure apparatus is further included, and the pressure apparatus is in communication with the first flow path or the second flow path, and is for a fluid in the first flow path or the second flow path to have a thrust force.

The present disclosure further provides another communicating method of a communicating structure. The communicating structure communicates a fluid to flow through a heat dissipater, a heat dissipation structure or a heat dissipation system for heat dissipation, or the heat dissipater, the heat dissipation structure or the heat dissipation system is for guiding heat generated from energizing a chip, an IC, a CPU, GPU, a battery, a power storage device or a memory to reduce a temperature, or the first flow path, the second flow path, the first block body or the second block body is for being assembled, removed or opened/closed to communicate the fluid, or wherein the first flow path, the second flow path, the first block body or the second block body has the fluid block body or the fluid absorption body for absorbing a fluid of the first flow path, the second flow path, the first block body or the second block body or between two block bodies, or wherein the fluid block body or the fluid absorption body is absorbing a fluid of the first flow path, the second flow path, the first block body or the second block body or between two block bodies that are closed, or for preventing a fluid from flowing to a chip or a circuit board, or for preventing a fluid from flowing to a chip or a circuit board and hence from causing short circuitry or contamination, or the first flow path or the second flow path of the communicating structure is a heat dissipater, a heat dissipation structure or a heat dissipation system.

The present disclosure further provides another communicating method of a communicating structure. The first block body is connected to a first dentate portion, the second block body is connected to a second dentate portion, the first dentate portion is turned to drive the second dentate portion to open the first flow path and the second flow path or to close the first flow path and the second flow path, or the first block body or the second block body is a valve, a ball valve, a lateral valve, a door valve or a valve body, or the first dentate portion or the second dentate portion is a gear or a rack.

The present disclosure further provides another communicating method of a communicating structure. The second body pushes the first block body to open the first flow path for a fluid to push the second block body to open the second path, or the second body pushes the first block body to open the first flow path for a fluid to flow into the second body to push the second block body, or wherein the second body pushes the first block body to open the first flow path closed by a resist portion and the first block body for a fluid to push the second block body to open the second path, or wherein the first body is provided with a resist portion, and the resist portion has at least one circulation portion to communicate a fluid, or for the second body to push the first block body to open the first flow path for a fluid to flow into the second body through the circulation portion, or for the second body to push the first block body to open the first flow path and for the resist portion to push the second block body for a fluid to flow into the second body, or wherein the second body pushes the first block body to open the first flow path closed by a resist portion and the first block body, and the resist portion is for the second block body to move in a direction for opening the second flow path for a fluid to push the second block body to open the second flow path, or wherein the second body pushes the first block body to open the first flow path closed by a resist portion and the first block body for a fluid to push the second block body to open the second flow path, or wherein the first body or the second body is installed at an object, and the object drives or is linked with the first body or the second body to insert into, assemble into, insert into in a blind manner or couple with in a blind manner the second body or the first body, or wherein an object is a PCB, PCB, a heat dissipater, a casing, an IC, a computer, an electrical conductor, a metal body, a non-metal body or a plastic body, or wherein the second body presses the first block body to open the first flow path closed by a resist portion and the first block body for a fluid to push the second block body to open the second flow path, or wherein the second body presses the first block body to open the first flow path closed by a resist portion and the first block body, and the resist portion is for the second block body to move in a direction for opening the second flow path for a fluid to push the second block body to open the second flow path, or wherein the second body presses the first block body to open the first flow path closed by a resist portion and the first block body, and the resist portion presses the second block body to open the second flow path, or wherein a body of the first block body is provided with a resist portion, and the resist portion has at least one circulation portion for communicating a fluid, or for a body of the second block body to press the first block body to open the first flow path for a fluid to flow into the second body via the circulation portion, or for the second body to press the first block body to open the first flow path and for the resist portion to push the second block body for a fluid to flow into the second body, or wherein the second body presses the first block body to open the first flow path closed by a resist portion and the first block body for a fluid to push the second block body to open the second flow path, wherein an elastic element is included to press against the second body and the second block body, for opening the second flow path when a force of the fluid is greater than a force of the elastic element, the force of the fluid is reduced when the second body moves in a direction for closing the first flow path, the flow path is closed when the force of the elastic element is greater than the force of the fluid, or the force of the fluid is reduced or the force of the fluid is stopped when the second body moves in a direction for closing the first flow path, and when the force of the elastic element is greater than the force of the fluid or when the force of the fluid is stopped, the second flow path is closed or the first flow path is closed, or the first flow path or the second flow path is simultaneously closed, or the first flow path is first closed and then the second flow path is closed, or the second flow path is first close and then the first flow path is close.

The present disclosure further provides another communicating method of a communicating structure. The communicating structure includes a first flow path and a second flow path; the first flow path has a first block body and a first body, and the second flow path has a second block body and a second body. The first body or the second body has an operating portion, which has an engaging portion for engagingly connecting at the second body or the first body, or the engaging portion has a pull portion, or for the pull portion to be pressed or pulled to open/close the engaging portion, or the engaging portion has an elastic element for elastic engagement connection of the engaging portion.

The present disclosure further provides another communicating method of a communicating structure. The communicating structure includes a first flow path and a second flow path; the first flow path has a first block body and a first body, and the second flow path has a second block body and a second body. The second body has a driving portion. The driving portion is for driving the first block body, or the driving portion is for driving the first block body to rotate or turn to open the first flow path, or wherein the driving portion is a dentate portion, a gear or a rack, or wherein the driving portion laterally or vertically drives a driving portion of the first body, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

The present disclosure further provides another communicating method of a communicating structure. The communicating structure includes a first flow path and a second flow path; the first flow path has a first block body and a first body, and the second flow path has a second block body and a second body. The first body has a driving portion. The driving portion is for driving the second block body, or the driving portion is for driving the second block body to rotate or turn to open the second flow path, or wherein the driving portion is a dentate portion, a gear or a rack, or wherein the driving portion laterally or vertically drives a driving portion of the second body, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

The present disclosure further provides another communicating method of a communicating structure. The communicating structure includes a first flow path and a second flow path; the first flow path has a first block body and a first body, and the second flow path has a second block body and a second body. The second body or the first body has a driving portion. The driving portion is for driving the second block body and the first block body, or the driving portion is for driving the second block body or the first block body to rotate or turn to open the first flow path or the second flow path, or wherein the driving portion is a dentate portion, a gear or a rack, or wherein the driving portion laterally or vertically drives a driving portion of the second body, or wherein the driving portion has a movement space for limiting movement, or wherein the driving portion has a limiting portion for limiting, positioning, temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion.

The present disclosure further provides another communicating method of a communicating structure. The communicating structure includes a first flow path and a second flow path; the first flow path has a first block body and a first body, and the second flow path has a second block body and a second body. The second body or the first body has a driving portion. The driving portion is for first driving one of the second block body or the first block body, and then driving one of the second block body or the first block body, for the second block body or the first block body to have different opening/closing sequences, or for the first block body or the second block body to be not closed when the second block body or the first block body is closed, or for a fluid to flow to the second block body or the first block body that is not closed, or for a fluid between the second block body or the first block body to flow into the first block body or the second block body that is not closed, or to close the first block body or the second block body when there is no fluid or when there is almost no fluid between the second block body or the first block body.

The present disclosure further provides another communicating method of a communicating structure. The communicating structure includes a first flow path and a second flow path; the first flow path has a first block body and a first body, and the second flow path has a second block body and a second body. The first body is provided with a communicating portion, the second body is provided with another communicating portion, the first flow path and the second flow path or the communicating portion and the another communicating portion are located at different heights, height differences, up and down positions or up and down position differences, or for a fluid to flow from a high position to a low position so that the fluid flows to a low position when the first block body or the second block body that is at a higher position is closed, or to reduce or completely block a fluid between the first block body and the second block body when both of the first block body and the second block body are closed.

The present disclosure further provides another communicating method of a communicating structure. The communicating structure includes a first flow path and a second flow path; the first flow path has a first block body and a first body, and the second flow path has a second block body and a second body. The first block body or the second block body has a torsion spring or an elastic element, and the torsion spring or the elastic element has one end press against the first body or the second body and the other end press against the first block body or the second block body, for the first block body or the second block body that is rotatable or turnable to normally press against a position at which the first flow path or the second flow path is closed, or for the first block body or the second block to normally press against a position at which the first flow path or the second flow path is open.

The present disclosure further provides another communicating method of a communicating structure. The communicating structure includes a first flow path and a second flow path; the first flow path has a first block body and a first body, and the second flow path has a second block body and a second body. The communicating structure is installed at a heat dissipater, or the heat dissipater is in contact with a heat generator for heat dissipation, or the heat generator is disposed in two heat dissipaters for heat dissipation, or the heat generator is disposed in one heat dissipater for heat dissipation, or wherein one heat dissipater is disposed with the communicating structure, or wherein two heat dissipaters are disposed with the communicating structure, or the heat dissipater is installed at an object, or the object is a printed circuit board, a metal body, a plastic body, a heat dissipater, a computer component, a casing component, a server component or a server casing, or the heat generator is a chip, a central process unit (CPU) or a graphics processing unit (GPU).

The present disclosure further provides another communicating method of a communicating structure. The communicating structure includes a first flow path and a second flow path; the first flow path has a first block body and a first body, and the second flow path has a second block body and a second body. The second block body and the second body or the first body have a flow space in between, for a fluid located between the first block body and the second block body to flow from the flow space or flow into the second body when the second body is closed, or for a fluid located between the first body and the second body to flow from the flow space or flow into the second body when the second body is closed, or the second block body has a fluid block body, or the second block body has a fluid block body at a position capable of delaying or later closing the flow space, or for closing inflow or outflow of a fluid in the flow space after the fluid passes through the flow space, or for closing the flow space, or for reducing or decreasing a fluid between the first block body and the second block body, or for reducing or decreasing a fluid between the first body and the second body.

Thus, the communicating structure of the present disclosure is capable of enabling a required fluid to flow stably in the first body and the second body.

### BRIEF DESCRIPTION OF THE DRAWINGS

FIG. 1 is a schematic diagram of a state of use according to a first embodiment of the present disclosure.

FIG. 2 is a schematic diagram of a second block body according to the first embodiment of the present disclosure.

FIG. 3 is a schematic diagram of a state of use according to a second embodiment of the present disclosure.

FIG. 4 is a schematic diagram of a second block body according to the second embodiment of the present disclosure.

FIG. 5 is a schematic diagram of different states of a first body and a second body of the present disclosure.

FIG. 6 is a first schematic diagram of a state of application of the present disclosure.

FIG. 7 is a second schematic diagram of a state of application of the present disclosure.

FIG. 8 is a schematic diagram of a state of use according to a third embodiment of the present disclosure.

FIG. 9 is a schematic diagram of a state of use according to a fourth embodiment of the present disclosure.

FIG. 10 is a schematic diagram of a state of use according to a fifth embodiment of the present disclosure.

FIG. 11 is a schematic diagram of a second block body according to the fifth embodiment of the present disclosure.

FIG. 12 is a schematic diagram of another second block body of the present disclosure.

FIG. 13 is a schematic diagram of a state of use according to a sixth embodiment of the present disclosure.

FIG. 14 is a schematic diagram of a state of use according to a seventh embodiment of the present disclosure.

FIG. 15 is a schematic diagram of a state of use according to an eighth embodiment of the present disclosure.

FIG. 16 is a schematic diagram of a state of use according to a ninth embodiment of the present disclosure.

FIG. 17 is a schematic diagram of a state of use according to a tenth embodiment of the present disclosure.

FIG. 18 is a schematic diagram of a state of use according to the tenth embodiment of the present disclosure.

FIG. 19 is a schematic diagram of a state of use according to an eleventh embodiment of the present disclosure.

FIG. 20 is a schematic diagram of a discharge portion according to the eleventh embodiment of the present disclosure.

FIG. 21 is a schematic diagram of a state of use according to a twelfth embodiment of the present disclosure.

FIG. 22 is a schematic diagram of a state of use according to a thirteenth embodiment of the present disclosure.

FIG. 23 is a schematic diagram of a state of use according to a fourteenth embodiment of the present disclosure.

FIG. 24 is a schematic diagram of a state of use according to a fifteenth embodiment of the present disclosure.

FIG. 25 is a schematic diagram of a state of use according to a sixteenth embodiment of the present disclosure.

FIG. 26 is a schematic diagram of a state of use according to a seventeenth embodiment of the present disclosure.

FIG. 27 is a schematic diagram of a state of use according to an eighteenth embodiment of the present disclosure.

FIG. 28 is a schematic diagram of a state of use according to a nineteenth embodiment of the present disclosure.

FIG. 29 is a schematic diagram of a state of use according to a twentieth embodiment of the present disclosure.

FIG. 30 is a schematic diagram of a state of use according to a twenty-first embodiment of the present disclosure.

FIG. 31 is a schematic diagram of a state of use according to a twenty-second embodiment of the present disclosure.

FIG. 32 is a schematic diagram of a state of use according to a twenty-third embodiment of the present disclosure.

FIG. 33 is a schematic diagram of a state of use according to a twenty-fourth embodiment of the present disclosure.

FIG. 34 is a schematic diagram of a state of use according to a twenty-fifth embodiment of the present disclosure.

FIG. 35 is a schematic diagram of a state of use according to a twenty-sixth embodiment of the present disclosure.

FIG. 36 is a schematic diagram of a state of use according to a twenty-seventh embodiment of the present disclosure.

FIG. 37 is a schematic diagram of a state of use according to a twenty-eighth embodiment of the present disclosure.

FIG. 38 is a schematic diagram of a state of use according to a twenty-ninth embodiment of the present disclosure.

FIG. 39 is a schematic diagram of a state of use according to a thirtieth embodiment of the present disclosure.

FIG. 40 is a schematic diagram of a state of use according to a thirty-first embodiment of the present disclosure.

FIG. 41 is a schematic diagram of a state of use according to a thirty-second embodiment of the present disclosure.

FIG. 42 is a schematic diagram of a state of use according to a thirty-third embodiment of the present disclosure.

FIG. 43 is a schematic diagram of a state of use according to a thirty-fourth embodiment of the present disclosure.

FIG. 44 is a schematic diagram of a state of use according to a thirty-fifth embodiment of the present disclosure.

FIG. 45 is a schematic diagram of a state of use according to a thirty-sixth embodiment of the present disclosure.

FIG. 46 is a schematic diagram of a state of use according to a thirty-seventh embodiment of the present disclosure.

FIG. 47 is a schematic diagram of a state of use according to a thirty-eighth embodiment of the present disclosure.

FIG. 48 is a schematic diagram of a state of use according to a thirty-ninth embodiment of the present disclosure.

FIG. 49 is a schematic diagram of a state of use according to a fortieth embodiment of the present disclosure.

### DETAILED DESCRIPTION OF THE INVENTION

To facilitate understanding of the object, characteristics and effects of this present disclosure, embodiments together with the attached drawings for the detailed description of the present disclosure are provided.

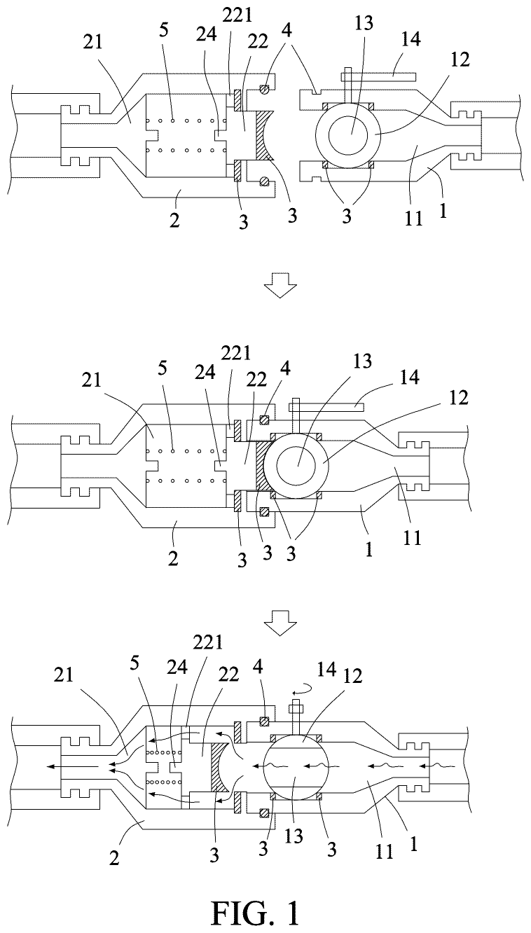

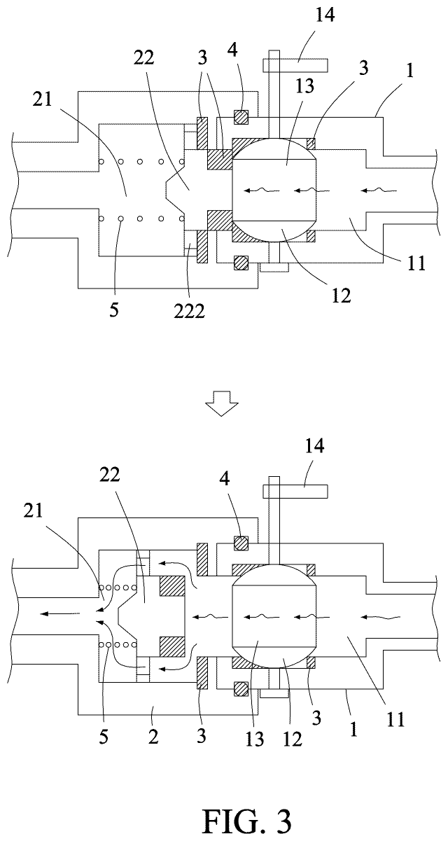

Referring to FIG. 1 to FIG. 7, the present disclosure provides a communicating structure, which includes a first body 1 and a second body 2.

The first body 1 includes a first flow path 11 which is movably provided with a first block body 12, and the first block body 12 is provided with a communicating portion 13.

The second body 2 includes a second flow path 21 which is movably provided with a second block body 22.

In one embodiment of the present disclosure, the first block body 12 can be rotated, turned, moved laterally or moved for the fluid to flow through the first flow path 11 and push the second block body 22 so as to open the second flow path 21, for a required fluid to flow stably in the first body 1 and the second body 2.

In the communicating structure 1 and the communicating method thereof of the present disclosure, the first block body 12 is first rotated, turned, moved laterally or moved to open the first flow path 11 so as to communicate the communicating portion 13 with the first flow path 11, and then the second block body 22 is moved laterally or moved to open the second flow path 21 so as to communicate the first flow path 11 and the second flow path 21. Moreover, the first block body 12 can also be first moved laterally or moved to open the first flow path 11, and then the second block body 22 is rotated, turned, moved laterally or moved to open the second flow path 21, so as to communicate the first flow path 11 and the second flow path 21.

In one embodiment of the present disclosure, the fluid is a water cooling liquid, a liquid, a gas, water or oil.

To put to use, the first block body 12 can be rotated, turned, moved laterally or moved to communicate the communicating portion 13 with the first flow path 11, for the fluid to flow through the first flow path 11 and the communicating portion 13 to the second block body 2, and for the fluid flowing through the second body 2 to push the second block body 22 and further for the second block body 22 to open the second flow path 21, allowing the fluid to flow in the first flow path 11 and the second flow path 21. Thus, the required fluid is enabled to flow stably in the first body 1 and the second body 2.

In addition to the embodiments above, in one embodiment of the present disclosure, the first block body 12 or the second block body 22 is a valve, a ball valve, a lateral valve, a door valve or a valve, and the first block body 12 or the second block body 22 is provided with a first operating portion 14. In this embodiment, the first block body 12 is a ball valve provided with the first operating portion 14, and the second block body 22 is a valve.

On the basis of the embodiments above, a force is applied to the first operating portion 14 to rotate, turn, move laterally or move the first block body 12 to communicate the communicating portion 13 with the first flow path 11, for the fluid to flow through the first flow path 11 and the communicating portion 13 to the second body 2, and for the fluid flowing through the second body 2 to push the second block body 22 and further for the second block body 22 to open the second flow path 21, allowing the fluid to flow in the first flow path 11 and the second flow path 21. Thus, the required fluid is enabled to flow stably in the first body 1 and the second body 2.

In addition to the embodiments above, in one embodiment of the present disclosure, the first operating portion 14 can be a pull body, a lever, a labor-saving structure, a wrench body, a rotating body, a threaded body, a rod, a recess, a protrusion, a shaft portion or a shaft. In this embodiment, the first operating portion 14 is a rotating body. Thus, the first operating portion 14 can be operated in a labor-saving manner to move the first block body 12, thereby enabling the first block body 12 of the present disclosure to better meet actual application requirements.

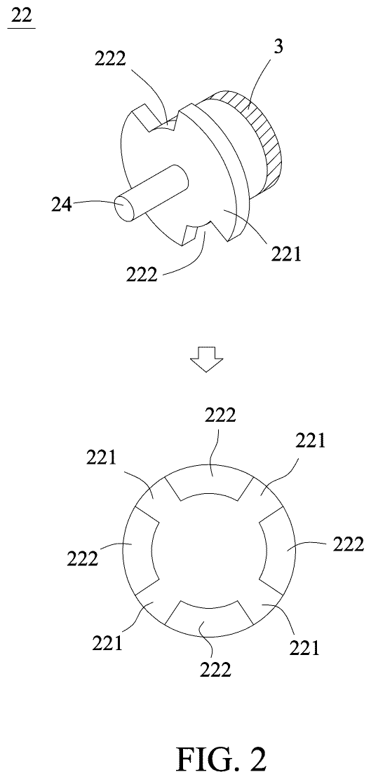

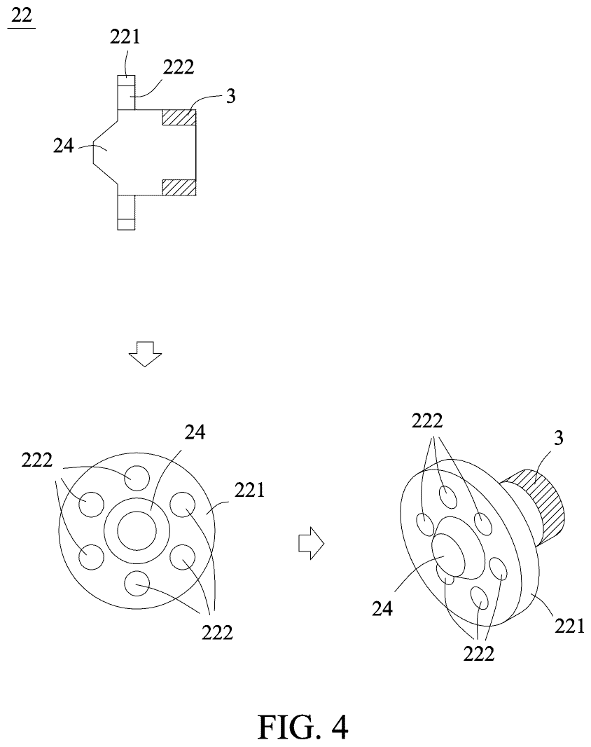

In addition to the embodiments above, in one embodiment of the present disclosure (as shown in FIG. 2 and FIG. 4), the second block body 22 is provided with a stop portion 221. The stop portion 221 limits a movement position of the second block body 22 (or the first block body 12), and the stop portion 221 is provided with at least one flow passage 222 which is in communication with the second flow path 21 (or the first flow path 11). Thus, when the fluid pushes the second block body 22, the second block body 22 can be moved to open the second flow path 21, and the movement position of the second block body 22 is limited by the stop portion 221, so that the second flow path 21 can be opened when the fluid pushes the second block body 22 for the fluid to flow in communication in the second flow path 21 and the flow passage 222. Thus, the required fluid is enabled to flow stably in the first body 1 and the second body 2.

In addition to the embodiments above, in one embodiment of the present disclosure, each of the first body 1, the first flow path 11, the first block body 12, the second body 2, the second flow path 21 and the second block body 22 is provided with a fluid block body 3 (or a fluid absorption body). The fluid block body 3 (or the fluid absorption body) can be an O-ring, a ring, an elastic body, foam, a cotton body, a suction fluid valve, a sponge body, a siphon, a foam body, a fiber body, a suction cotton body, a recyclable material body, a decomposable material body, a glue body, a buffer body or a fluid absorbing object. Thus, by absorbing the fluid between the first body 1 and the second body 2, the fluid between the first block body 12 and the second block body 22, the fluid in the first flow path 11, or the fluid in the second flow path 21 by the fluid block bodies 3 (or the fluid absorption bodies), fluid leakage from the first body 1 and the second body 2 is prevented in a communicating state or a non-communicating state.

In addition to the embodiments above, in one embodiment of the present disclosure, the first block body 12, the second block body 22, the first body 1 or the second body 2 has a fluid absorption body (or the fluid block body 3). The position of the fluid absorption body does not come into contact with a fluid when the fluid flows, and when one of the first block body 12 and the second block body 22 is closed, or when both of the first block body 12 and the second block body 22 are closed, or when the first body 1 and the second body 2 are separated, a fluid not closed by the first block body 12 or the second block body 22, or the fluid residing between the first block body 12, the second block body 22, the first body 1 or the second body 2 is absorbed by the fluid absorption body, so as to prevent fluid leakage from the first body 1 and the second body 2 in a communicating state or a non-communicating state.

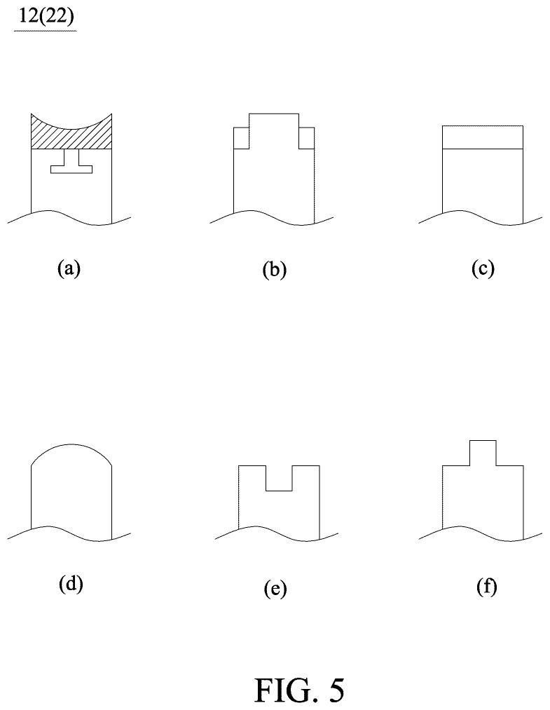

In addition to the embodiments above, in one embodiment of the present disclosure, the first block body 12, the second block body 22 and the fluid block body 3 (or the fluid absorption body) can be corresponding structures, for the first block body 12 and the second block body 22 to come into contact with, block against or elastically block against each other in between. Corresponding parts of the first block body 12 and the second block body 22 are arcs (as shown in part a in FIG. 5), slopes, steps (as shown in part b in FIG. 5), planes (as shown in part c in FIG. 5), curves (as shown in part d in FIG. 5), recesses (as shown in part e in FIG. 5) or protrusions (as shown in part f in FIG. 5). Moreover, the first block body 12, the second block body 22 or the fluid block body 3 (or the fluid absorption body) can be a corresponding structure, for a space storage between the first block body 12 and the second block body 22 to be less than 500 c.c. Thus, fluid leakage from the first block body 12 and the second block body 22 can be prevented in a communicating state or a non-communicating state.

In addition to the embodiments above, in one embodiment of the present disclosure, the first block body 12 or the second block body 22 is installed with, interferes with, has, in contact with or is adjacent to the fluid block body 3 (or the fluid absorption body), or wherein the first block body 12 or the second block body 22 is the fluid block body (or the fluid absorption body), or wherein the fluid block body 3 (or the fluid absorption body) can absorb the fluid in the first block body 12 or the second block body 22 (or between two block bodies), so as to prevent fluid leakage from the first body 1 and the second body 2 in a communicating state or a non-communicating state.

In addition to the embodiments above, in one embodiment of the present disclosure, the first block body 12 or the second block body 22 is installed with, interferes with, has, in contact with or is adjacent to the fluid block body 3 (or the fluid absorption body), or the first block body 12 or the second block body 22 is the fluid block body (or the fluid absorption body), wherein a part of the fluid block body 3 (or the fluid absorption body) corresponding with any object is an arc, a slope, a step, a plane, a curve, a recess, a protrusion, or a structure capable of fitting with, interfering with or getting close to any object, so as to prevent fluid leakage from the first body 1 and the second body 2 in a communicating state or a non-communicating state.

In addition to the embodiments above, in one embodiment of the present disclosure, the first body 1 and the second body 2 are provided with an engaging body 4 in between. The engaging body 4 engages the first body 1 and the second body 2, and can be an elastic engaging body, a bead, a plastic fastener, a metal engaging body, a labor-saving engaging body, a spring engaging body, or a lever engaging body. Thus, the first body 1 and the second body 2 can be securely coupled.

Moreover, in the communicating method of the present disclosure, the engaging body 4 can engage the first body 1 and the second body 2, the first block body 12 is first rotated, turned, moved laterally or moved to open the first flow path 11 to communicate the communicating portion 13 with the first flow path 11, and then the second block body 22 is moved laterally or moved to open the second flow path 22 to communicate the first flow path 11 and the second flow path 12.

In addition to the embodiments above, in one embodiment of the present disclosure, the second body 2 is provided with an elastic element 5. Two ends of the elastic element 5 respectively press against the second body 2 and the second block body 22, and an elastic force of the elastic element 5 is less than a dynamic force or a thrust force of the fluid flowing to the second flow path 22. Moreover, the elastic force of the elastic element 5 can also be less than the dynamic force or the thrust force of the fluid flowing from the first body 1 to the second flow path 22. Thus, the second block body 22 can be pushed when the fluid flows to the second body 2, and the elastic element 5 is compressed at the same time to open the second flow path 21 by the second block body 22 for the fluid to flow in communication in the second flow path 21 and the flow passage 22. When the fluid is not communicated, due to elastic restoration of the elastic element 5, the first block body 12 and the second block body 22 elastically resist against each other. Thus, the required fluid is enabled to flow stably in the first body 1 and the second body 2.

On the basis of the embodiments above, in the communicating method of the present disclosure, the first block body 12 can be first rotated, turned, moved laterally or moved to open the first flow path 11 to communicate the communicating portion 13 with the first flow path 11, and then the second block body 22 pressed by the elastic element 5 is pushed by the dynamic force or the thrust force of the fluid to communicate the first flow path 11 and the second flow path 12, wherein the dynamic force or the thrust force of the fluid is greater than the elastic force of the elastic element 5.

In addition to the embodiments above, in one embodiment of the present disclosure, a limiting portion 24 is provided on one end of the second block body 22. The limiting portion 24 can guide and limit a movement distance of the elastic element 5 for the elastic element 5 to achieve an effect of stable extension and contraction.

In addition to the embodiments above, in one embodiment of the present disclosure, the second body 2 can have a limiting power or a limiting structure (for example, the elastic element 5 above) for limiting the second block body 22, or the limiting power or a force of the limiting structure is less than the dynamic force or the thrust force of the fluid flowing from the first body 1 to the second flow path 21 and is for pushing the second block body 22 to open the second flow path 21, or the limiting force or the limiting structure is an elastic force, an elastic structure, a structure capable of reciprocating motion, a force capable of reciprocating motion, a fluid force, a gas force or electrically driven force, thereby enabling the present disclosure to better meet actual application requirements.

In addition to the embodiments above, in one embodiment of the present disclosure, the first flow path 11, the second flow path 21 or the communicating portion 13 can be groove-shaped, hole-shaped or tubular-shaped. Thus, the first flow path 11 and the second flow path 21 in different shapes can be selected according to actual application requirements.

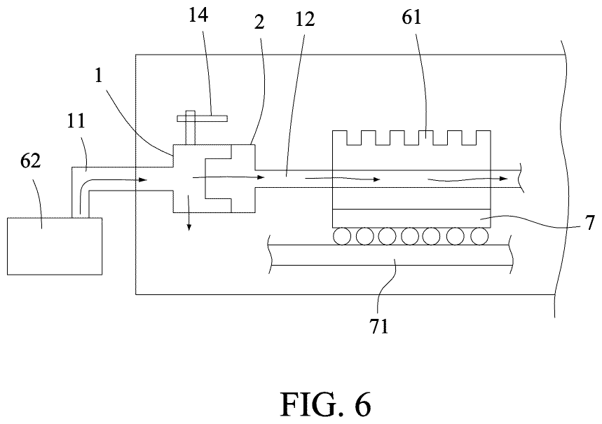

In addition to the embodiments above, in one embodiment of the present disclosure (as shown in FIG. 6), the communicating structure of the present disclosure can be installed at an object 6 according to requirements. The object 6 can be a cabinet, a frame, a casing, a data center, a server, a storage device, a heat dissipater, a heat sink, a metal body, a plastic body, an electronic device, a mechanical device, a liquid cooling device, an engineering device or a computer, and the first flow path 11 and the second flow path 21 of the communicating structure 1 can flow through a heat dissipater 61 (or a heat generator) for heat dissipation. Moreover, a pressure apparatus 62 is further included. The pressure apparatus 62 is in communication with the first flow path 11 and the second flow path 12, and is for the fluid in the first flow path 11 and the second flow path 22 to have a thrust force, and for the fluid to flow through the heat dissipater 61 to perform heat dissipation.

In addition to the embodiments above, in one embodiment of the present disclosure, the first body 1 and the second body 2 are fixed at the object 6, and the object 6 can be a cabinet, a frame, a casing, a data center, a computer, a server, a storage device, a heat dissipater, a heat sink, a metal body or a plastic body, for the first body 1 and the second body 2 to be coupled in a fixed manner, a linear manner, an aligned manner, a floating manner, a blind manner or a positioned manner, or wherein the fluid is a water cooling liquid, a liquid, a gas, water or oil.

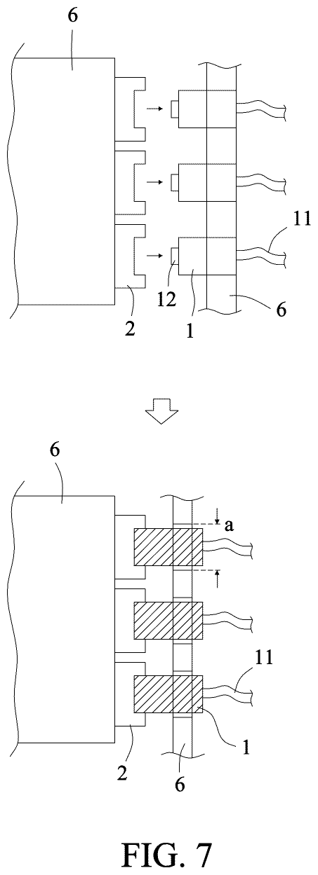

In addition to the embodiments above, in one embodiment of the present disclosure (as shown in FIG. 7), the first body 1 and the second body 2 are fixed at the object 6, for the first body 1 and the second body 2 to be coupled in a fixed manner, a linear manner, a floating manner, an aligned manner, a blind manner or a positioned manner. Moreover, the object 6, the first body 1 and the second body 2 (or a flow path and a flow passage) have a floating space a in between. The floating space a facilitates the first body 1 and the second body 2 to be coupled in a fixed manner, a linear manner, a floating manner, an aligned manner, a floating manner, a blind manner, or a positioned manner. Thus, the present disclosure is enabled to better meet actual application requirements.

In addition to the embodiments above, in one embodiment of the present disclosure, the differences from the embodiments above are that, the first body 1 and the second body 2 are installed at the object 6, the object 6 drives or is linked with the first body 1 or the second body 2 to insert into, assemble into, insert into in a blind manner, or couple with in a blind manner the second body 2 and the first body 1, and the object 6 can be a printed circuit board (PCB), a heat dissipater, a casing, an integrated circuit (IC), a computer, an electrical conductor, a metal body, a non-metal body or a plastic body. Thus, the present disclosure is enabled to better meet actual application requirements.

In addition to the embodiments above, in one embodiment of the present disclosure, the communicating structure 1 communicates a fluid to flow through the heat dissipater 61 (a heat dissipation structure or a heat dissipation system) for heat dissipation, or the heat dissipater (the heat dissipation structure or the heat dissipation system) is for guiding heat generated from energizing a chip 7, an IC, a CPU, GPU, a battery, a power storage device or a memory to reduce a temperature. The first flow path 11, the second flow path 21, the first block body 12 and the second block body 22 are for being assembled, removed or opened/closed to communicate the fluid. The first flow path 11, the second flow path 21, the first block body 12 and the second block body 22 have the fluid block body 3 (or the fluid absorption body) for absorbing the fluid between the first flow path 11, the second flow path 21, the first block body 12 or the second block body 22 (or two block bodies), or for absorbing the fluid between the first flow path 11, the second flow path 21, the first block body 12 or the second block body 22 (or two block bodies) that is/are closed, so as to prevent a fluid from flowing to a chip 7 or a circuit board 71 and hence from causing short circuitry or contamination. Moreover, the first flow path 11 and the second flow path 12 of the communicating structure can also be the heat dissipater 61 (the heat dissipation structure or the heat dissipation system).

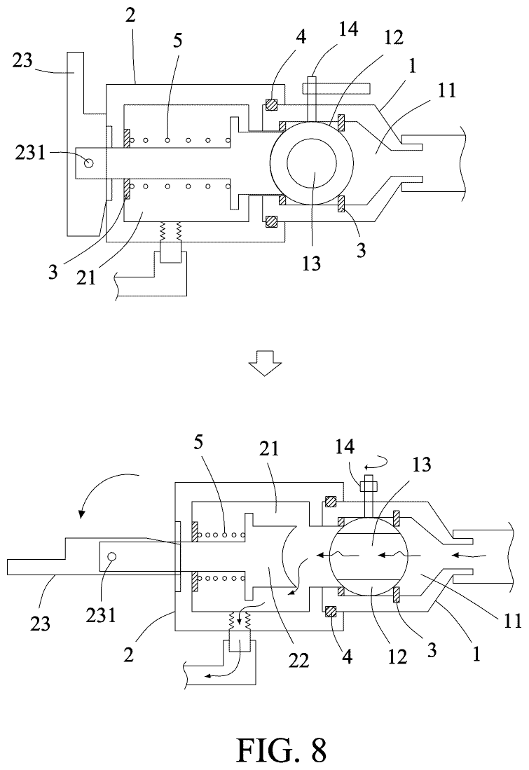

Referring to FIG. 8, in addition to the embodiments above, in one embodiment of the present disclosure, the differences from the embodiments above are that, the second block body 22 is provided with a second operating portion 23 which couples the second block body 22 by a bolt portion 231. The second operating portion 23 can be a wrench body, a rod, a recess, a protrusion, a shaft portion or a shaft. In this embodiment, the second operating portion 23 is a wrench body, so as to move the second block body 22 by a labor-saving leverage operation.

On the basis of the embodiments above, when put to use, a force can be applied to the first operating portion 14 to rotate, turn, move laterally or move the first block body 12, and a force is applied to the second operating portion 23 to rotate, turn, move laterally or move the second block body 22, so as to communicate the first flow path 11, the communicating portion 13 and the second flow path 21 with each other. Thus, the fluid is enabled to flow in the first flow path 11 and the second flow path 21.

In addition to the embodiments above, in one embodiment of the present disclosure, the stop portion 221 limits movement positions of the second block body 22 and the second operating portion 23. Thus, the required fluid is enabled to flow stably in the first body 1 and the second body 2.

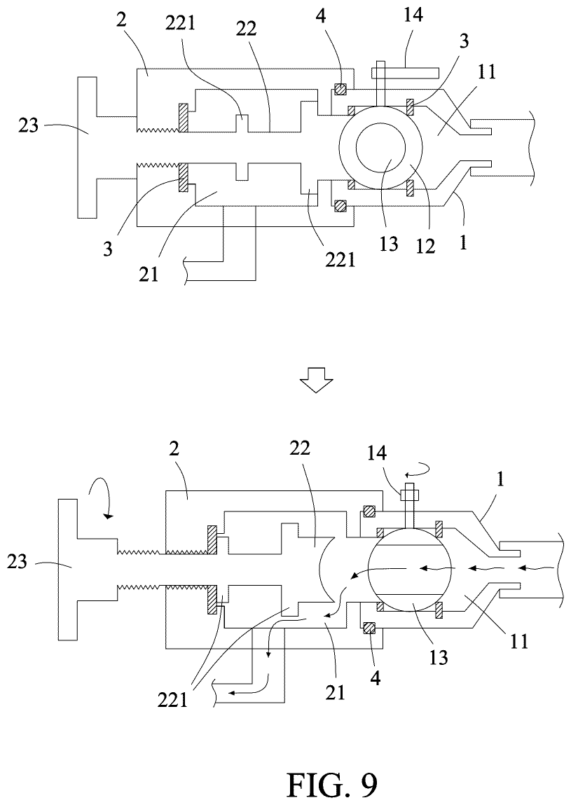

Referring to FIG. 9, in addition to the embodiments above, in one embodiment of the present disclosure, the differences from the embodiments above are that, the first block body 12 is a ball valve provided with the first operating portion 14, and the second block body 22 is a threaded body (or a rotating body) provided with the second operating portion 23. Thus, a force can be applied to the first operating portion 14 to rotate, turn, move laterally or move the first block body 12, and a force is applied to the second operating portion 23 to rotate, turn, move laterally or move the second block body 22 by a labor-saving screwing operation of the threaded body, so as to communicate the first flow path 11, the communicating portion 13 and the second flow path 21 with each other. Thus, the fluid is enabled to flow in the first flow path 11 and the second flow path 21.

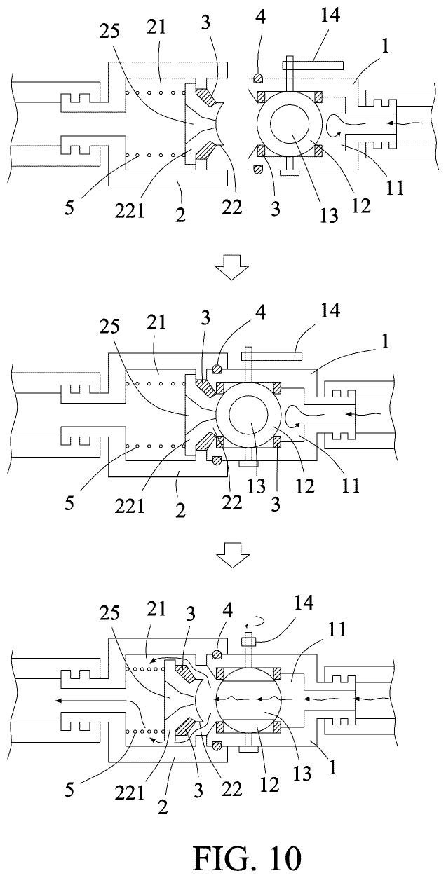

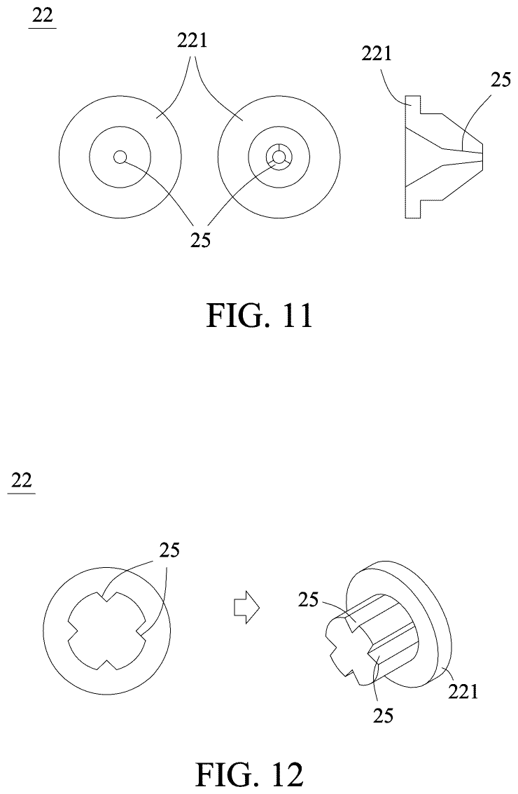

Referring to FIG. 10 to FIG. 12, in addition to the embodiments above, in one embodiment of the present disclosure, the differences from the embodiments above are that, the first body 1, the first block body 12, the second body 2 and the second block body 22 have sloped surfaces, curved surfaces, arc surfaces or diversion structures to facilitate a fluid flow or discharge. In this embodiment, the second block body 22 (or the first block body 12) can have a discharge portion 25, so as to unidirectionally discharge part of the fluid between the first body 1 and the second body 2, or to discharge the fluid between the first block body 12 and the second block body 22 from the discharge portion 25 when the first flow path 11 or the second flow path 12 is not communicated.

In addition to the embodiments above, in one embodiment of the present disclosure, the discharge portion 25 can be a hole, a tapered hole, a dilating hole, a groove, a notch, a piston, a plug, an object for one-way discharge of a fluid, an object for restricting one-way discharge of a fluid, a fluid absorption body, a soft body, a hard body, a one-way valve, a rubber body, a silicone body, a check body, a stop check body, a non-return valve, a stop check valve, a leakproof body, a rubber body, a silicone body, a structure with incision, a structure with an opening, a structure with a unidirectional incision, a structure with an unidirectional opening, a metal body or a plastic body. In this embodiment, the second block body 22 is a plug, and the first block body 12 and the second block body 22 are corresponding structures in between (or corresponding spaces), for a fluid storage space between the first block body 12 and the second block body 22 to be less than 500 c.c. Thus, fluid leakage from the first block body 12 and the second block body 22 can be prevented in a communicating state or a non-communicating state. Thus, the second block body 22 of the present disclosure can coordinate with the discharge portion 25 to better meet actual application requirements.

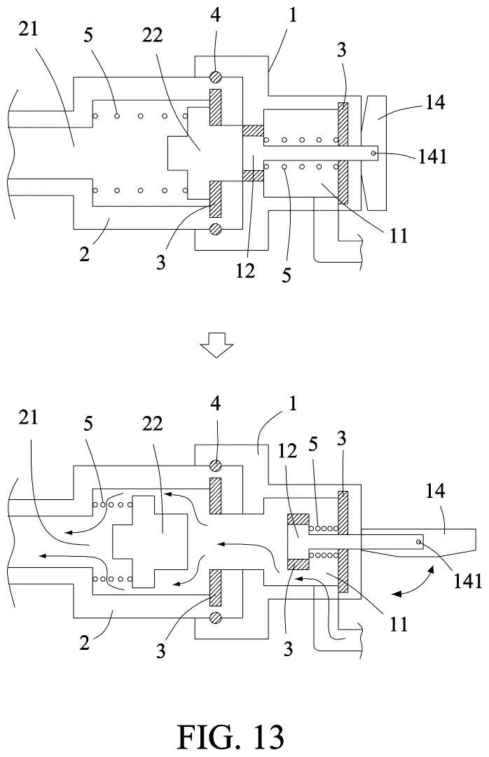

Referring to FIG. 13, in addition to the embodiments above, in one embodiment of the present disclosure, the differences from the embodiments above are that, the first body 1 includes a first flow path 11 which is movably provided with a first block body 12, and the second body 2 includes a second flow path 21 which is movably provided with a second block body 22.

In addition to the embodiments above, in one embodiment of the present disclosure, each of the first body 1 and the second body 2 is provided with an elastic element 5. Two ends of one of the elastic elements 5 respectively press against the first body 1 and the first block body 12, and two ends of the other of the elastic elements 5 respectively press against the second body 2 and the second block body 22.

In addition to the embodiments above, in one embodiment of the present disclosure, the first operating portion 14 is coupled to the first block body 12 by a bolt portion 141, so as to produce a force by means of pulling to operate the first block body 12 to move laterally or move.

On the basis of the embodiments above, when put to use, the engaging body 4 can engage the first body 1 and the second body 2, a force is applied to rotate, turn, move laterally or move the first operating portion 14 for the first block body 12 to first move laterally or move to open the first flow path 11 to communicate the communicating portion 13 with the first flow path 11, for the fluid to flow through the first flow path 11 to push the second block body 22 and for the second block body 22 to open the second flow path 21, enabling the fluid to flow in the first path 11 and the second flow path 12. Thus, the present disclosure is enabled to better meet actual application requirements.

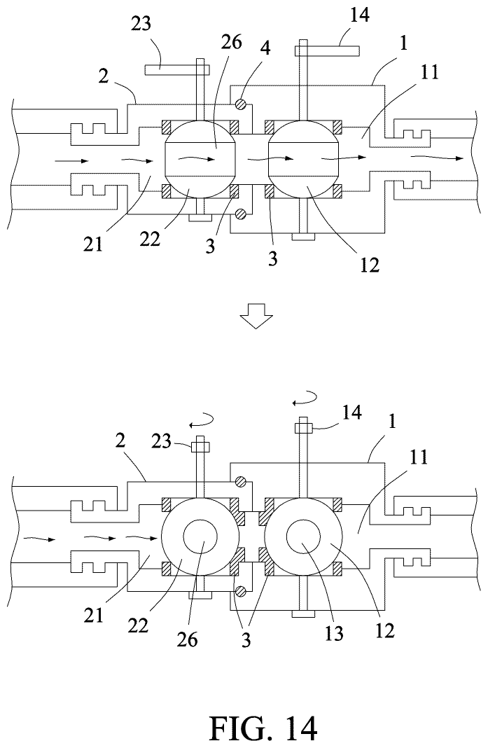

Referring to FIG. 14, in addition to the embodiments above, in one embodiment of the present disclosure, the differences from the embodiments above are that, the first block body 12 is a ball valve provided with the first operating portion 14, and the second block body 22 is a ball valve having another communicating portion 26 and provided with the second operating portion 23. Thus, a force can be applied to the first operating portion 14 to rotate, turn, move laterally or move the first block body 12, and a force is applied to the second operating portion 23 to rotate, turn, move laterally or move the second block body 22, so as to communicate the first flow path 11, the communicating portion 13, the another communicating portion 26 and the second flow path 12 with each other. Thus, the fluid is enabled to flow in the first flow path 11 and the second flow path 21, thereby enabling the present disclosure to better meet actual application requirements.

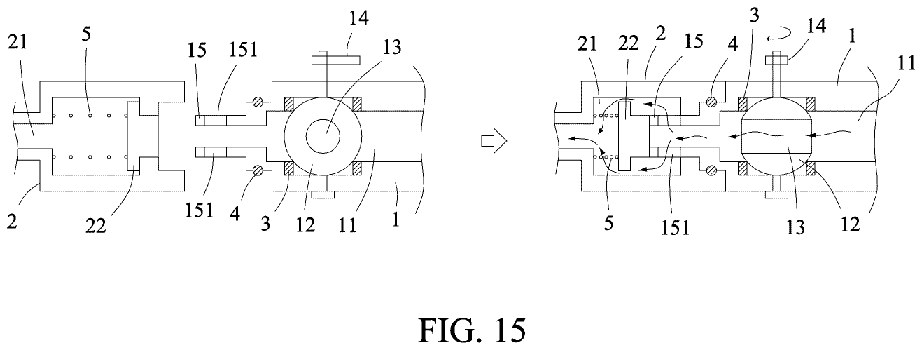

Referring to FIG. 15, in addition to the embodiments above, in one embodiment of the present disclosure, the differences from the embodiments above are that, the first body 1 is provided with a push portion 15 which pushes the second block body 22 in the second body 2.

In addition to the embodiments above, in one embodiment of the present disclosure, the push portion 15 has a channel 151, the fluid is communicated via the channel 151 when the push portion 15 enters the second body 2, and the channel 151 is located on a lateral position of the push portion 15.

On the basis of the embodiments above, when put to use, the engaging body 4 can engage the first body 1 and the second body 2 for the push portion 15 to push the second block body 22 in the second body 2 so as to first open the second flow path 21 after the second block body 22 moves, and then the first block body 12 is rotated, turned, moved laterally or moved to open the first flow path 11 to communicate the communicating portion 13 with the first flow path 11, for the fluid to flow through the first flow path 11 and the communicating portion 13 in a direction to the second flow path 12, thereby enabling the present disclosure to better meet actual application requirements.

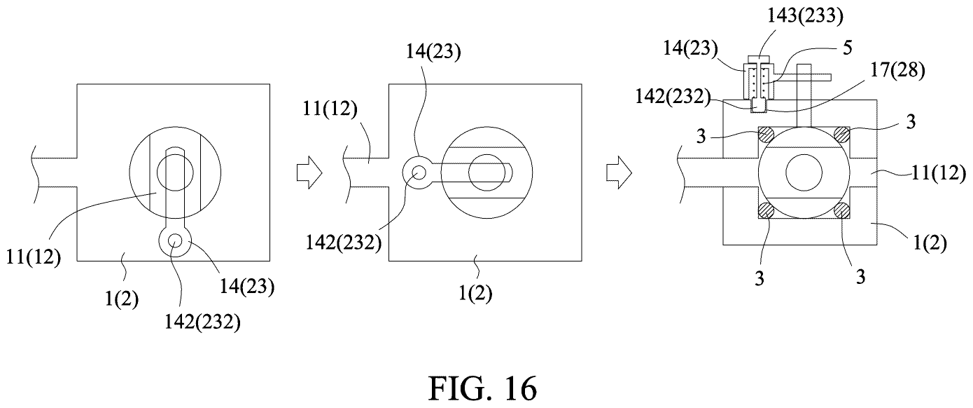

Referring to FIG. 16, in addition to the embodiments above, in one embodiment of the present disclosure, the differences from the embodiments above are that, the first operating portion 14 has a first positioning portion 142 or the second operating portion 23 has a second positioning portion 232. The first positioning portion 142 or the second positioning portion 232 is for positioning the first block body 12 or the second block body 22 to be limited at a position at which a flow path is opened or at a position at which a flow path is closed, further enabling the required fluid to flow stably in the first body 1 and the second body 2.

In addition to the embodiments above, in one embodiment of the present disclosure, the first positioning portion 142 and the second positioning portion 232 can also be disposed at the first block body 12, the second block body 22, the first body 1 or the second body 2 according to requirements, thereby enabling the present disclosure to better meet actual application requirements.

In addition to the embodiments above, in one embodiment of the present disclosure, the first positioning portion 142 or the second positioning portion 232 can be an engaging body, an engaging portion or a limiting portion, thereby enabling the present disclosure to better meet actual application requirements.

In addition to the embodiments above, in one embodiment of the present disclosure, the elastic element 5 is for the first positioning portion 142 or the second positioning portion 232 to be elastically engagingly connected at the first body 1 or the second body 2, for the first block body 12 or the second block body 22 to be limited at a position at which a flow path is opened or at a position at which a flow path is closed.

In addition to the embodiments above, in one embodiment of the present disclosure, a first lift portion 143 is provided on one end of the first positioning portion 142, or a second lift portion 233 is provided on one end of the second positioning portion 232. A force is applied to the first lift portion 143 or the second lift portion 233 to coordinate with the elastic element 5 to limit the first positioning portion 142 or the second positioning portion 232 at a first corresponding recess 17 of the first body 1 or a second corresponding recess 28 of the second body 2, for the first block body 12 or the second block body 22 to be secured at a position at which a flow path is opened or at a position at which a flow path is closed.

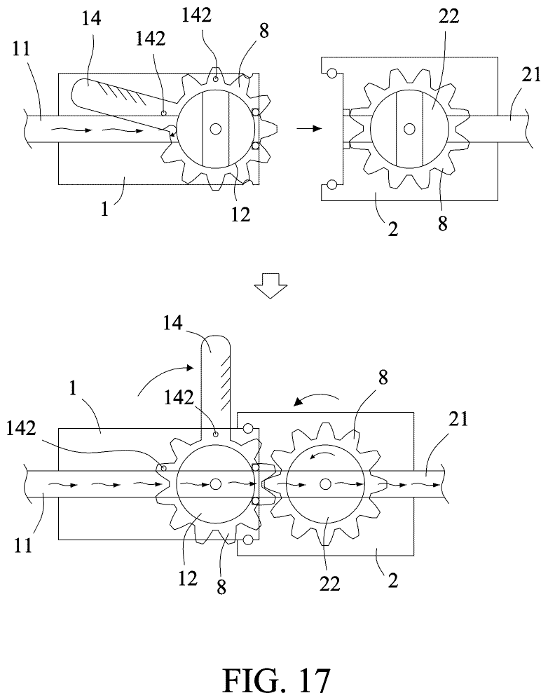

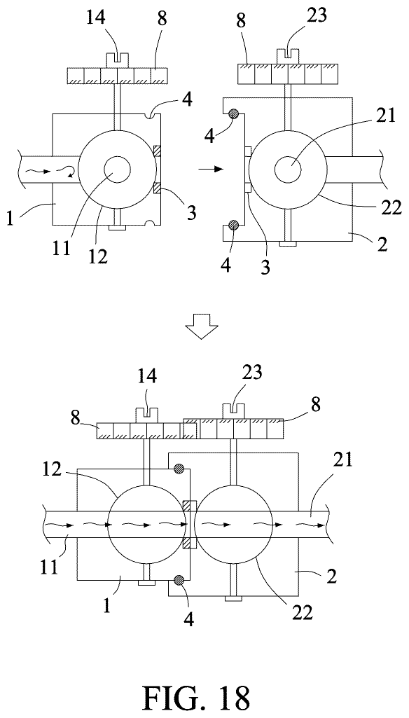

Referring to FIG. 17 and FIG. 18, in addition to the embodiments above, in one embodiment of the present disclosure, the differences from the embodiments above are that, a driving body 8 is provided at each of the first block body 12 and the second block body 22. The driving body 8 is for driving, driving mutually, driving relatively, compelling, compelling mutually, compelling relatively, moving, moving mutually, moving relatively, operating, operating mutually, turning or turning relatively so as to open the first flow path 11 and the second flow path 21, thereby enabling the present disclosure to better meet actual application requirements.

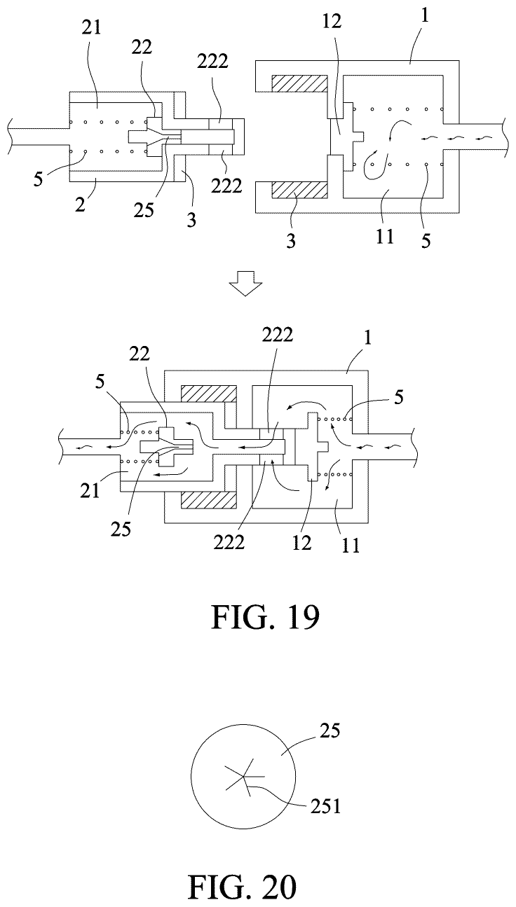

Referring to FIG. 19 and FIG. 20, in addition to the embodiments above, in one embodiment of the present disclosure, the differences from the embodiments above are that, the second body 2 pushes the first block body 12 to open the first flow path 11, for the fluid to flow into the second body 2 and push the second block body 22 to open the second flow path 21 and for the fluid to flow in communication in the second flow path 21 and the flow passage 222, thereby enabling the present disclosure to better meet actual application requirements.

In addition to the embodiments above, in one embodiment of the present disclosure, the differences from the embodiments above are that, when the first flow path 11 and the second flow path 12 are not communicated, part of the fluid between the first body 1 and the second body 2 can be unidirectionally discharged from an incision of the discharge portion 25, or the fluid between the first block body 12 and the second block body 22 can be discharged, thereby enabling the present disclosure to better meet actual application requirements.

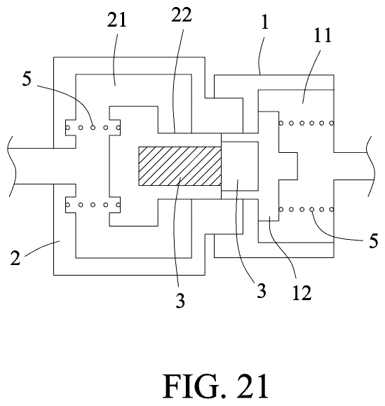

Referring to FIG. 21, in addition to the embodiments above, in one embodiment of the present disclosure, the differences from the embodiments above are that, each of the first block body 12 and the second block body 22 can have the fluid block body 3 (or the fluid absorption body), a pushing position of the first block body 12 or the second block body 22 is provided with the fluid block body 3 (or the fluid absorption body), and pushing positions of the first block body 12 and the second block body 22 are provided with the fluid block body 3 (or the fluid absorption body). Thus, the first fluid between the first flow path 11, the second flow path 21, the first block body 12 and the second block body 22 can be absorbed by the fluid block body 3 (or the fluid absorption body), thereby enabling the present disclosure to better meet actual application requirements.

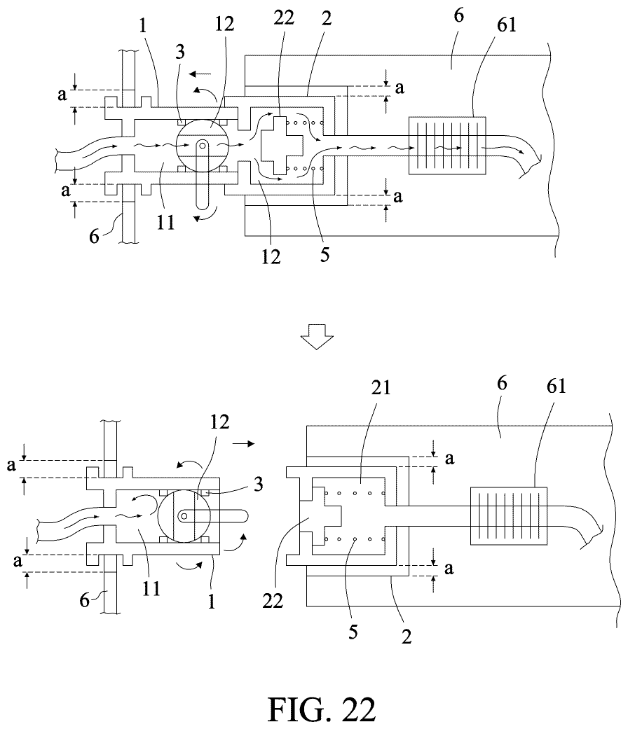

Referring to FIG. 22, in addition to the embodiments above, in one embodiment of the present disclosure, the differences from the embodiments above are that, the first body 1 and the second body 2 can be assembled at the object 6, and the object 6 can be a casing, a cabinet, a metal body, a plastic body or a printed circuit board according to requirements, for the first flow path 11 and the second flow path 21 to flow through the heat dissipater 61 (or a heat generator) to perform heat dissipation. Moreover, the first body 1, the second body 2 and the object 6 have the floating space a in between, and the floating space a is for correcting or guiding coupling of the first body 1, the first flow path 11, the second body 2 and the second flow path 12, thereby enabling the present disclosure to better meet actual application requirements.

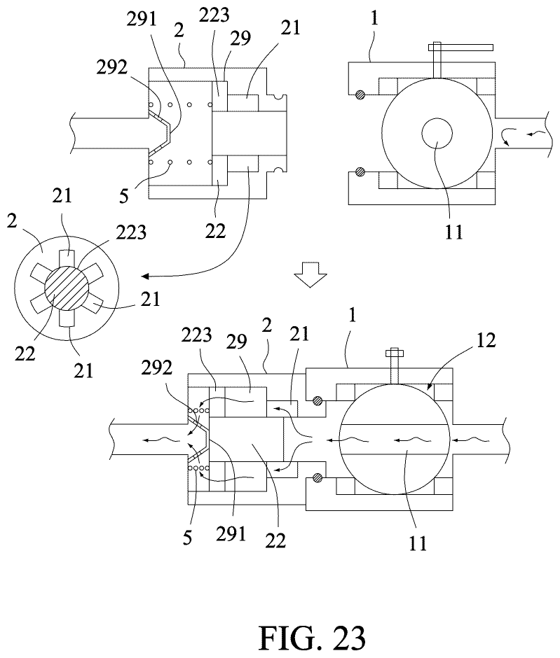

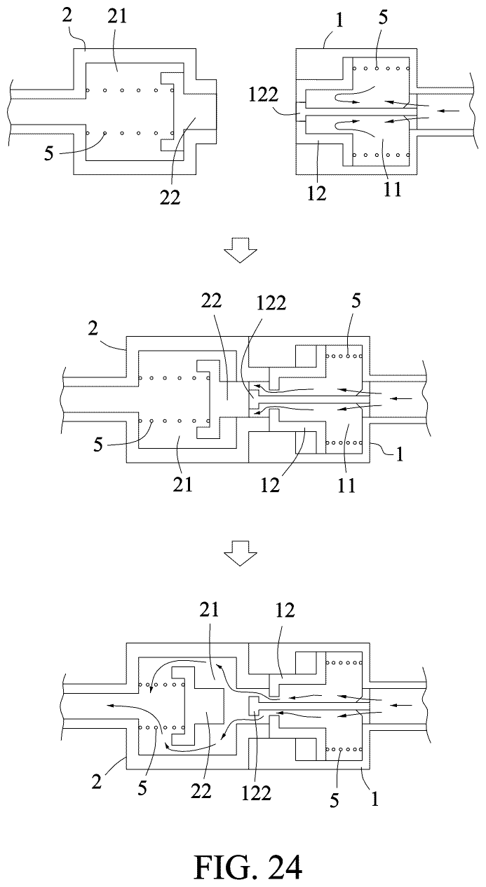

Referring to FIG. 23, in addition to the embodiments above, in one embodiment of the present disclosure, the differences from the embodiments above are that, the second body 2 is provided with at least one track 29, the second block body 22 is provided with a guide portion 223 movably provided at the track 29, and the track 29 is for coordinating with the guide portion to guide or regularize the second block body 22.

In one embodiment of the present disclosure, the differences from the embodiments above are that, the second body 2 is provided with a resist portion 291, the resist portion 291 is provided with at least one through hole 292, and the through hole 292 is in communication with the second flow path 21.

In one embodiment of the present disclosure, the differences from the embodiments above are that, a width of the second flow path 21 is the same as or corresponds to that of the second block body 22. When the fluid flows through the first flow path 11 and enters the second body 2, the fluid can push the second block body 22 and guide or regularize, by the coordination of the guide portion 223 and the track 29, the second block body 22 to recede. Moreover, the receding position of the second block body 22 is limited by the resist portion 291, for the fluid to pass through the second flow path 21 and a part of the second flow path 21 non-corresponding to the second block body 22, and to flow from the second flow path 21 to the through hole 292, thereby enabling the required fluid to flow stably in the first body and the second body.

Referring to FIG. 23, in addition to the embodiments above, in one embodiment of the present disclosure, the differences from the embodiments above are that, the first block body 12 (or the first body 1) is provided with a resist portion 122 for the second body 2 to push the first block body 12 so as to open the first flow path 11 closed by the resist portion 122 and the first block portion 22, or for the second body 22 to push the first block body 12 so as to open the first flow path 11 closed by the resist portion 122 and the first block body 11, and for the resist portion 122 to push the second block body 22 so as to open the second flow path 21, thereby enabling the present disclosure to better meet actual application requirements.

In one embodiment of the present disclosure, the differences from the embodiments above are that, the second body 2 pushes the first block body 12 to open the first flow path 11 closed by the resist portion 122 and the first block body 12, and the resist portion 122 is for moving the second block body 22 in a direction for opening the second flow path 21, for the fluid to push the second block 22 to open the second flow path 21, thereby enabling the present disclosure to better meet actual application requirements.

In one embodiment of the present disclosure, the differences from the embodiments above are that, the second body 2 pushes the first block body 12 to open the first flow path 11 closed by the resist portion 122 and the first block body 12, for the fluid to push the second block body 22 to open the second flow path 21, wherein an elastic element 5 presses against the second body 2 and the second block body 22, to open the second flow path 21 when the force of the fluid is greater than the force of the elastic element 5, to reduce the force of the fluid when the second body 2 moves in a direction for closing the first flow path 11, and to close the flow path when the force of the elastic element 5 is greater than the force of the fluid.

In one embodiment of the present disclosure, the differences from the embodiments above are that, when the second body 2 moves in a direction for closing the first flow path 11, the force of the fluid is reduced or the force of the fluid is stopped, and when the force of the elastic element 5 is greater than the force of the fluid or when the force of the fluid is stopped, the second flow path 21 is closed or the first flow path 11 is closed, or the first flow path 11 or the second flow path 21 is simultaneously closed, or the first flow path 11 is first closed and then the second flow path 21 is closed, or the second flow path 21 is first closed and then the first flow path 11 is closed. Thus, the present disclosure is enabled to better meet actual application requirements.

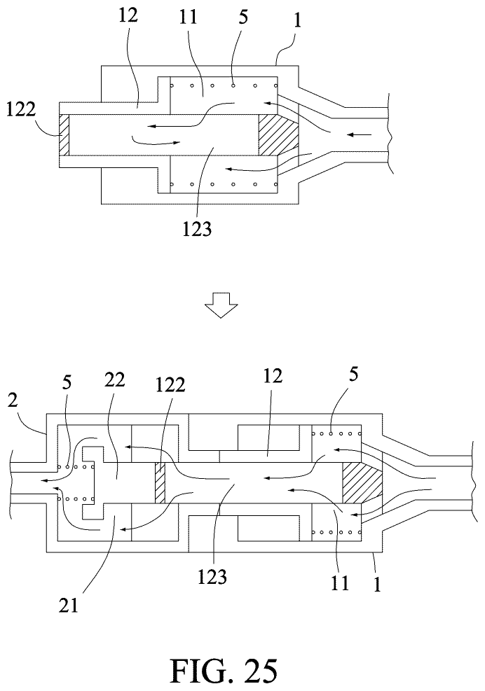

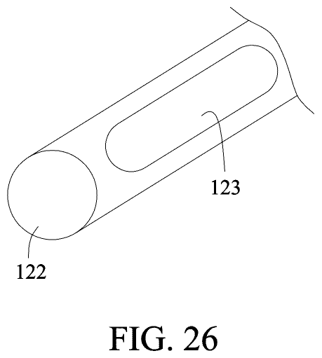

Referring to FIG. 25 and FIG. 26, in addition to the embodiment above, in one embodiment of the present disclosure, the differences from the embodiments above are that, the resist portion 122 is disposed at the first block body 12 and has at least one circulation portion 123, and the circulation portion 123 can be a notch to communicate the fluid, thereby enabling the present disclosure to better meet actual application requirements.

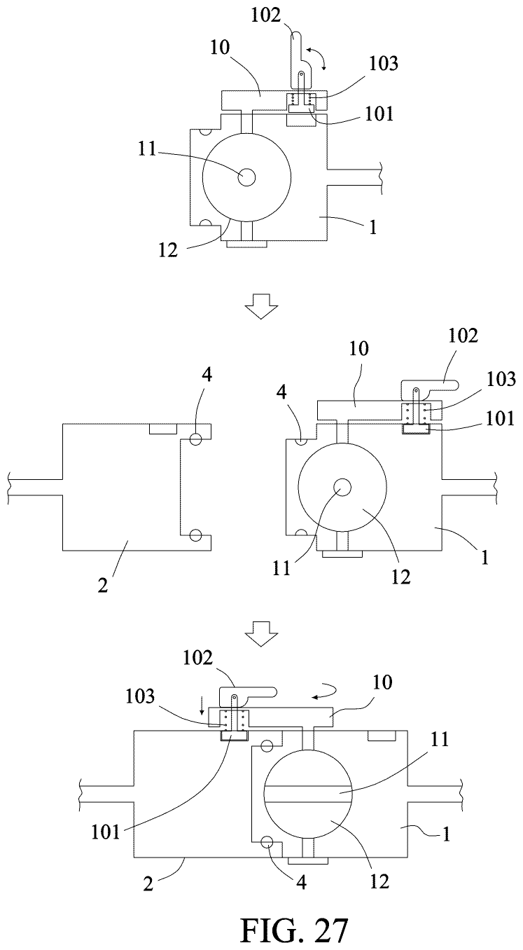

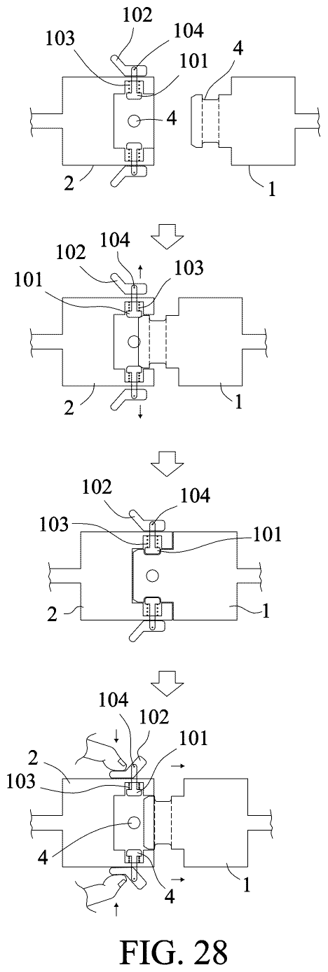

Referring to FIG. 27 and FIG. 28, in addition to the embodiment above, in one embodiment of the communicating structure and the communicating method thereof of the present disclosure, the differences from the embodiments above are that, the first body 1 (or the second body 2) has an operating portion 10. The operating portion 10 has an engaging portion 101 for engagingly connecting at the second body 2 (or the first body 1), the engaging portion 101 has a pull portion 102, and the pull portion 102 and the engaging portion 101 are bolted with each other by a bolt 104. When put to use, the pull portion 101 is pressed or pulled to open/close the engaging portion 101. Moreover, the engaging portion 101 has an elastic element 103 for the engaging portion 101 to perform elastic engagement connection, thereby enabling the present disclosure to better meet actual application requirements.

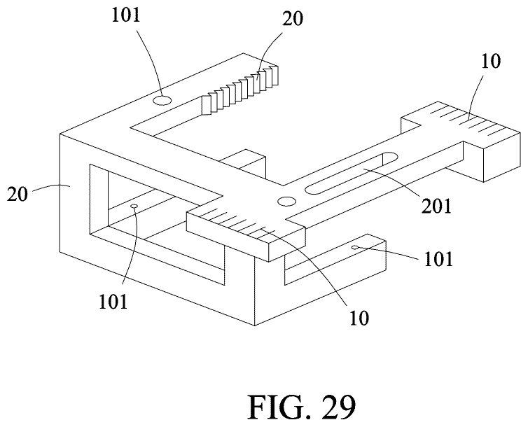

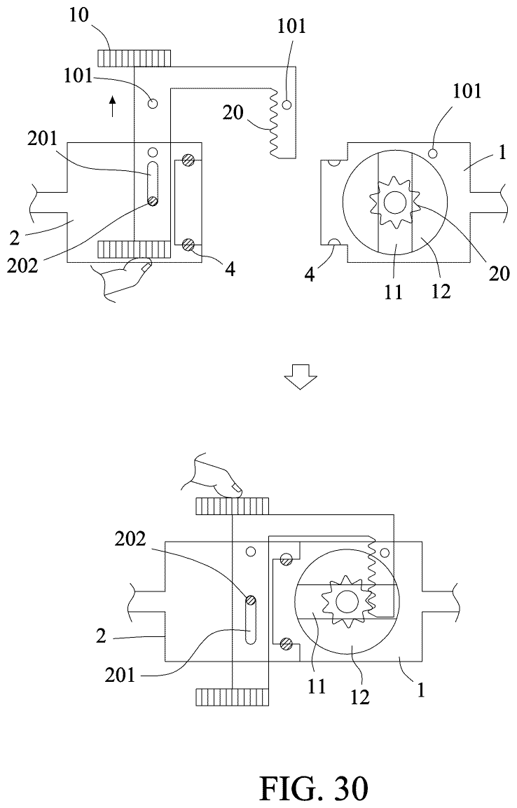

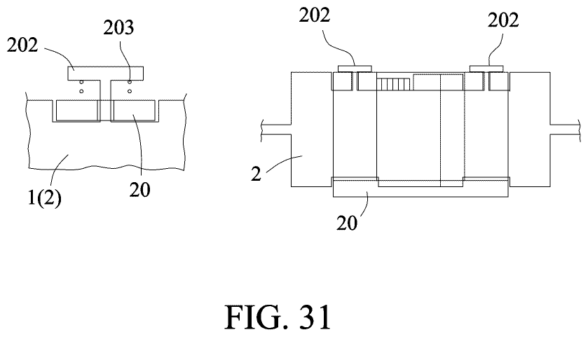

Referring to FIG. 29 and FIG. 31, in addition to the embodiment above, in one embodiment of the communicating structure and the communicating method thereof of the present disclosure, the differences from the embodiments above are that, the second body 2 has a driving portion 20. The driving portion 20 is for driving the first block body 12 for the first block body 12 to rotate or turn to open the first flow path 11. The driving portion 20 is a dentate portion, a gear, a rack, a column, a sliding body, a support body, or a structure top-bottom engagingly connected, assembled or slidably connected at the second body 2 or the first body 1. The driving portion 20 laterally or vertically drives a driving portion 20 of the first body 1. The driving portion 20 has a movement space 201 for limiting movement, and further has a limiting portion 202 for limiting, positioning, temporary positioning. The first body 1 or the second body 2 has a limiting portion 202 for limiting, positioning or temporary positioning, and the limiting portion 202 has an elastic element 203 for elastically pressing against the driving portion 20. Moreover, the driving portion is 20 has an operating portion 10 for operating the driving portion 20.

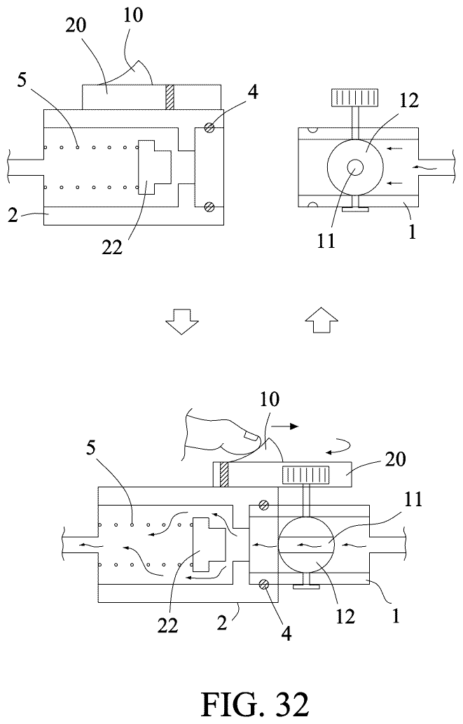

Referring to FIG. 32, in addition to the embodiment above, in one embodiment of the communicating structure and the communicating method thereof of the present disclosure, the differences from the embodiments above are that, the first body 1 has a driving portion 20. The driving portion 20 is for driving the second block body 22 for the second block body 22 to rotate or turn to open the second flow path 21. The driving portion 20 is a dentate portion, a gear, a rack, a column, a sliding body, a support body, or a structure top-bottom engagingly connected, assembled or slidably connected at the second body 2 or the first body 1. The driving portion 20 laterally or vertically drives a driving portion 20 of the second body 2. The driving portion 20 has a movement space 201 for limiting movement, and further has a limiting portion 202 for limiting, positioning, temporary positioning. The first body 1 or the second body 2 has a limiting portion 202 for limiting, positioning or temporary positioning, and the limiting portion 202 has an elastic element 203 for elastically pressing against the driving portion 20. Moreover, the driving portion is 20 has an operating portion 10 for operating the driving portion 20.

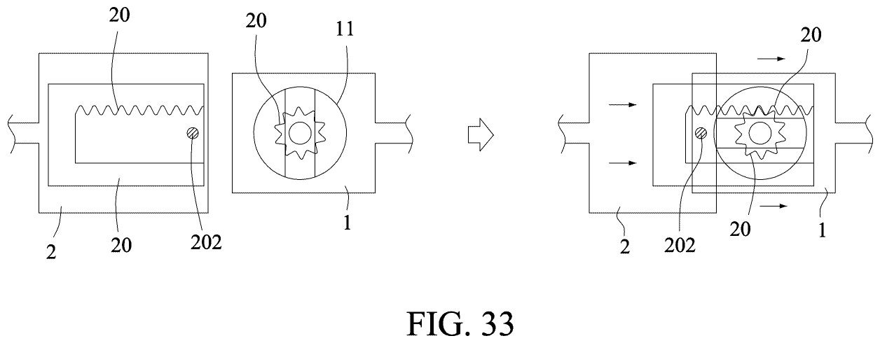

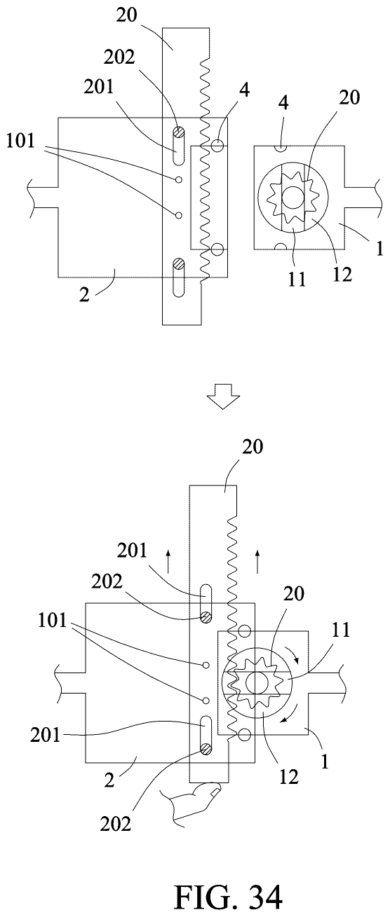

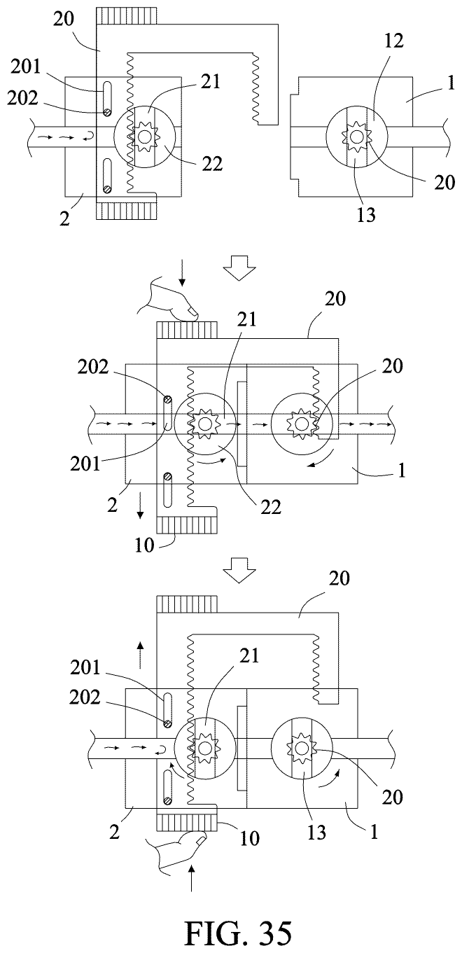

Referring to FIG. 33 to FIG. 35, in addition to the embodiment above, in one embodiment of the communicating structure and the communicating method thereof of the present disclosure, the differences from the embodiments above are that, each of the first body 1 and the second body 2 can have a driving portion 20. The driving portion 20 is for driving the first block body 12 and the second block body 22 for the first block body 12 and the second block body 22 to rotate or turn to open the first flow path 11 and the second flow path 21. The driving portion 20 is a dentate portion, a gear, a rack, a column, a sliding body, a support body, or a structure top-bottom engagingly connected, assembled or slidably connected at the second body 2 or the first body 1. The driving portion 20 laterally or vertically drives a driving portion 20 of the second body 2. The driving portion 20 has a movement space 201 for limiting movement, and further has a limiting portion 202 for limiting, positioning, temporary positioning. The first body 1 or the second body 2 has a limiting portion 202 for limiting, positioning or temporary positioning, and the limiting portion 202 has an elastic element 203 for elastically pressing against the driving portion 20. Moreover, the driving portion is 20 has an operating portion 10 for operating the driving portion 20.

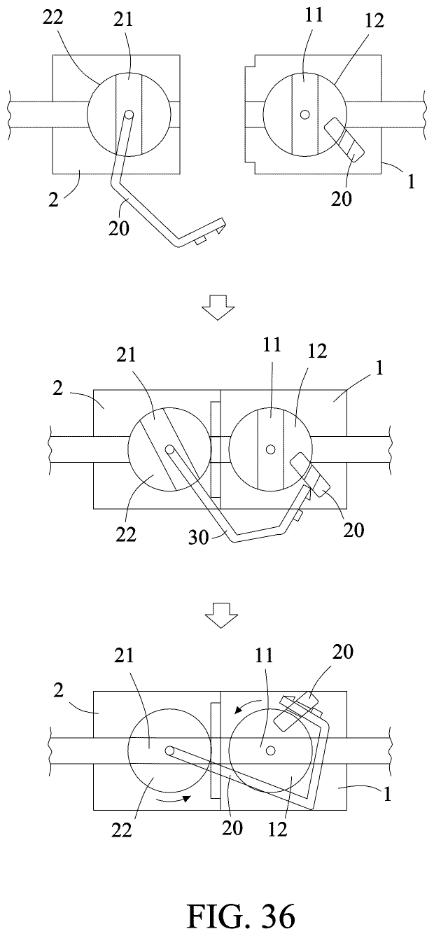

Referring to FIG. 36, in addition to the embodiment above, in one embodiment of the communicating structure and the communicating method thereof of the present disclosure, the differences from the embodiments above are that, each of the second body 2 and the first body 1 can have a driving portion 20. The driving portion is for first driving one of the second block body 22 or the first block body 12, and then driving one of the second block body 22 or the first block body 12, for the second block body 22 or the first block body 12 to have different opening/closing sequences, for the first block body 12 or the second block body 22 to be not closed when the second block body 22 or the first block body 12 is closed, for the fluid to flow to the second block body 22 or the first block body 12 that is not closed, or for the fluid between the second block body 22 or the first block body 12 to flow into the first block body 12 or the second block body 22 that is not closed, or to close the first block body 12 or the second block body 22 when there is no fluid or when there is almost no fluid between the second block body 22 or the first block body 12.

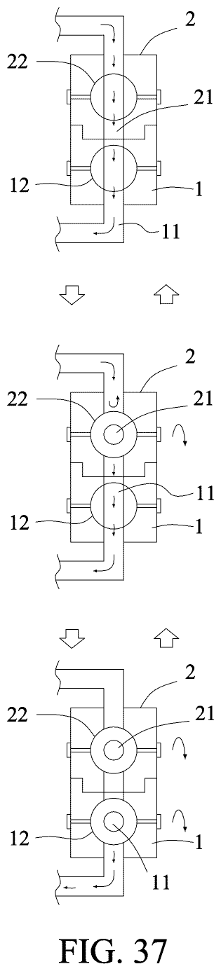

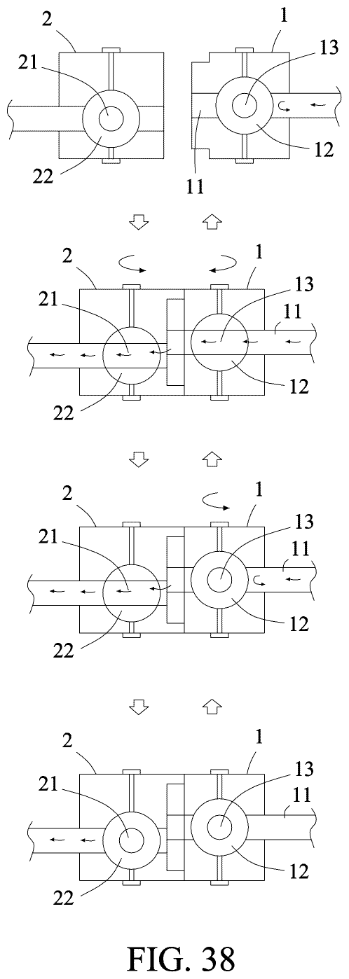

Referring to FIG. 37 and FIG. 38, in addition to the embodiment above, in one embodiment of the communicating structure and the communicating method thereof of the present disclosure, the differences from the embodiments above are that, the first flow path 11 and the second flow path 21 or the communicating portion 13 and the another communicating portion 26 are located at different heights, height differences, up and down positions or up and down position differences, for the fluid to flow from a high position to a low position so that the fluid flows to a low position when the first block body 12 or the second block body 22 that is at a higher position is closed, so as to reduce or completely block the fluid between the first block body 12 and the second block body 22 when both of the first block body 12 and the second block body 22 are closed.

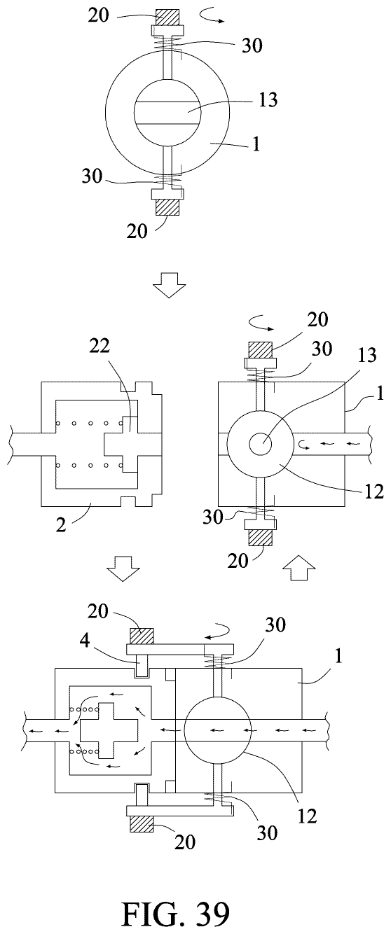

Referring to FIG. 39, in addition to the embodiment above, in one embodiment of the communicating structure and the communicating method thereof of the present disclosure, the differences from the embodiments above are that, the first block body 12 (or the second block body 22) has a torsion spring 30 (or an elastic element). The torsion spring 30 (or the elastic element) has one end press against the first body 1 (or the second body 2) and the other end press against the first block body 12 (or the second block body 22), for the first block body 12 (or the second block body 22) that is rotatable or turnable to normally press against a position at which the first flow path 11 (or the second flow path 21) is closed, or for the first block body 12 (or the second block 22) to normally press against a position at which the first flow path 11 (or the second flow path 21) is open.

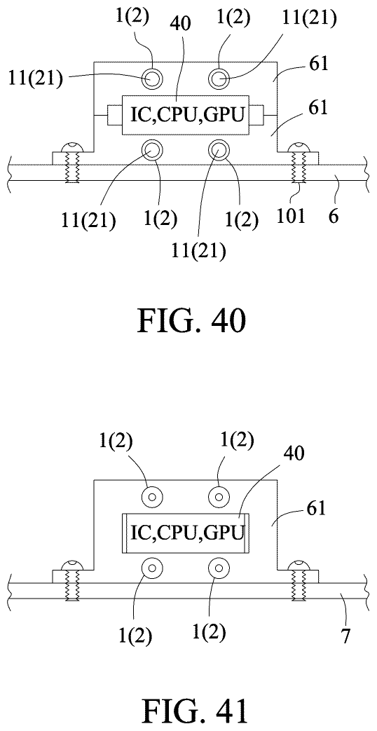

Referring to FIG. 40 and FIG. 41, in addition to the embodiment above, in one embodiment of the communicating structure and the communicating method thereof of the present disclosure, the differences from the embodiments above are that, the communicating structure 1 is installed at a heat dissipater 61, or the heat dissipater 61 is in contact with a heat generator 40 for heat dissipation. In one embodiment, the heat generator 40 is disposed in two heat dissipaters 61 for heat dissipation (as shown in FIG. 40), or the heat generator 40 is disposed in one heat dissipater 61 for heat dissipation (as shown in FIG. 41), or wherein one heat dissipater 61 is disposed with or two heat dissipaters 61 are disposed with the communicating structure, and the heat dissipater 61 can be installed at an object 6 for further use, wherein the object 6 can be a printed circuit board, a metal body, a plastic body, a heat dissipater, a computer component, a casing component, a server component or a server casing, or the heat generator is a chip, a central process unit (CPU) or a graphics processing unit (GPU).

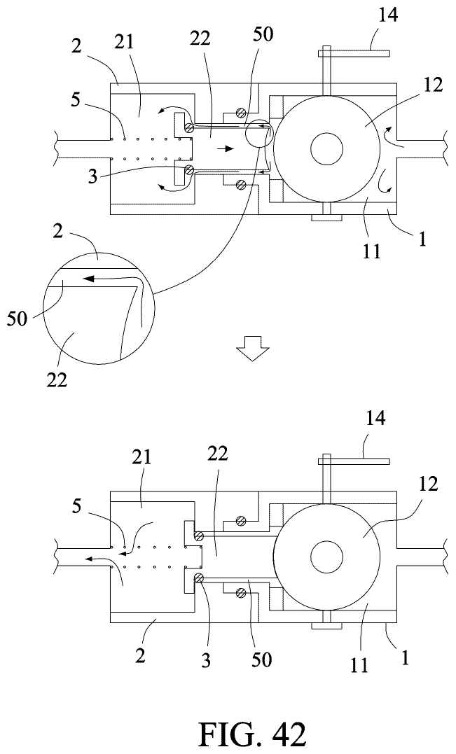

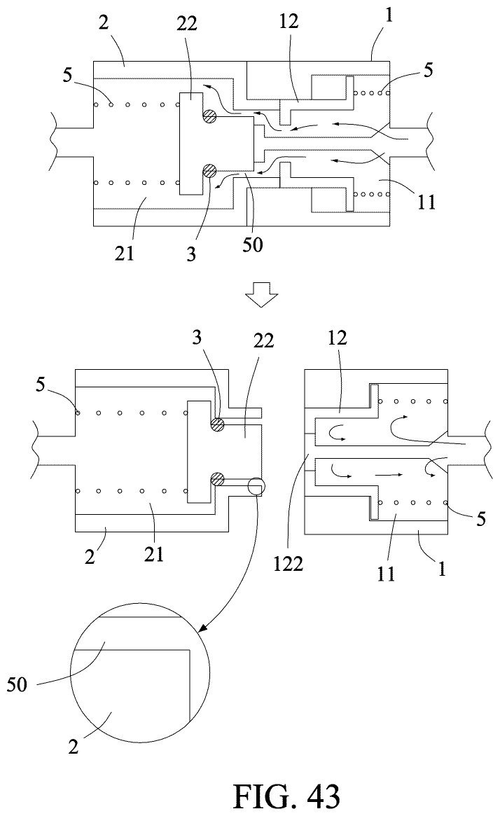

Referring to FIG. 42 and FIG. 43, in addition to the embodiment above, in one embodiment of the communicating structure and the communicating method thereof of the present disclosure, the differences from the embodiments above are that, the communicating structure at least has a flow space 50 between the second block body 22, the second body 2 and the first body 1, for the fluid located between the first block body 12 and the second block body 22 to flow from the flow space 50 to (or flow into) the second body 2 when the second body 2 is closed, or for the fluid located between the first body 1 and the second body 2 to flow from the flow space 50 to (or flow into) the second body 2 when the second body 2 is closed. Moreover, the second block body 22 has a fluid block body 3, the fluid block body 22 is located at a position capable of delaying or later closing the flow space 50, and the fluid block body 22 is for closing inflow (or outflow) of the fluid in the flow space 50 after the fluid passes through the flow space 50, or the fluid block body 22 is for closing the flow space 50, so as to reduce (or decrease) the fluid between the first block body 12 and the second block body 22, or to reduce (or decrease) the fluid between the first body 1 and the second body 2.

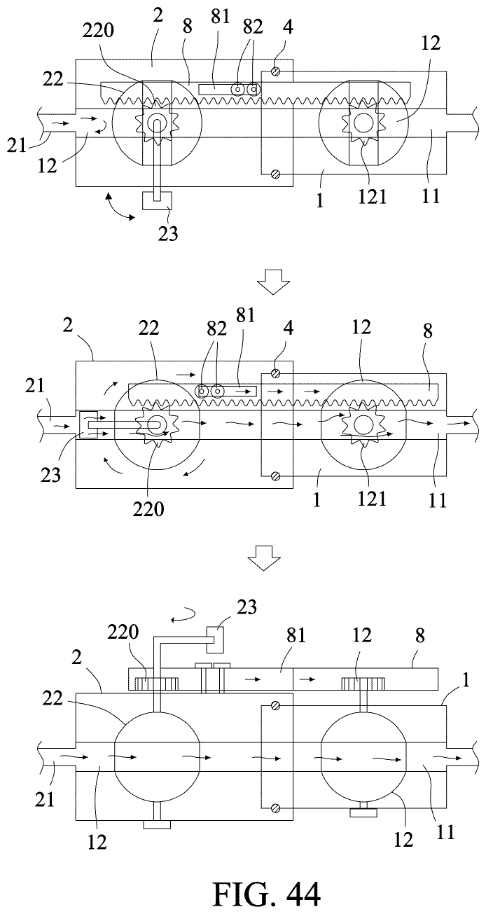

Referring to FIG. 44, in addition to the embodiment above, in one embodiment of the present disclosure, the differences from the embodiments above are that, the first block body 12 and the second block body 22 are rotating bodies, the first block body 12 is provided with a first dentate portion 121, the second block 22 is provided with a second dentate portion 221, the first body 1 or the second body 2 is provided with a corresponding dentate portion 8, and the corresponding dentate portion 8 drives the first dentate portion 121 and the second dentate portion 221, so as to drive the first block body 12 and the second block body 22 to respectively open the first flow path 11 and the second flow path 21.

In addition to the embodiments above, in one embodiment of the present disclosure, each of the first dentate portion 121, the second dentate portion 221 and the corresponding dentate portion 8 is a gear or a rack.

In addition to the embodiments above, in one embodiment of the present disclosure, the corresponding dentate portion 8 has a movement space 81. The movement space 81 coordinating with a fixing portion 82 is fixed at the first body 1, the second body 2 or the object 6 (fixed at the second body 2 in this embodiment), and the corresponding dentate portion 8 is limited in the movement space 81 as a driving or movement range.

In addition to the embodiments above, in one embodiment of the present disclosure, the second block body 22 has a second operating portion 23, which is for driving or operating the second block body 22.

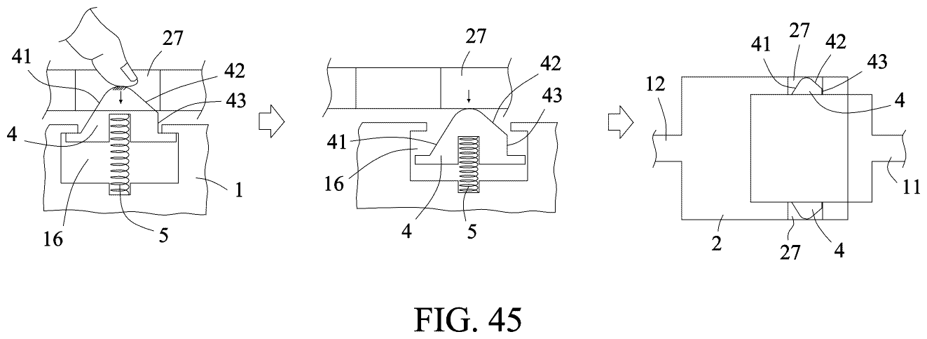

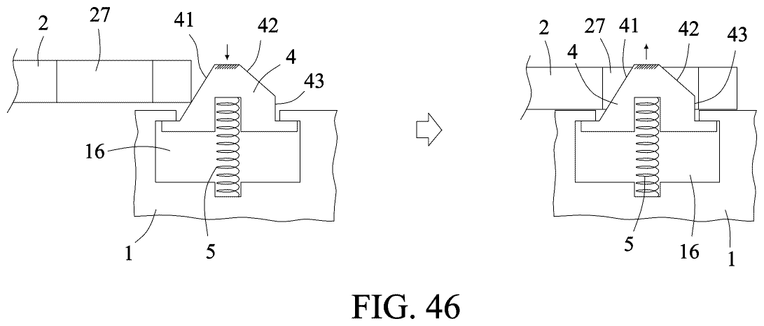

Referring to FIG. 45 and FIG. 46, in addition to the embodiment above, in one embodiment of the present disclosure, the differences from the embodiments above are that, the engaging body 4 is disposed in a storage space 16 of the first body 1, two ends of the elastic element 5 respectively press against the engaging body 4 and the first body 1 (or the second body 2), the engaging body 4 engages an engagement receiving portion 27 of the second body 2 (or the first body 1), the engaging portion 4 has a first guide surface 41 on one side and has a second guide surface 42 and an engagement connection surface 43 on the other side, the first guide surface 41 and the engagement connection surface 43 are engaged into the engagement receiving portion 27, and the engaging body 4 is moved to depart from the engagement receiving portion 27 by the second guide surface 42, so as to separate the first body 1 and the second body 2.

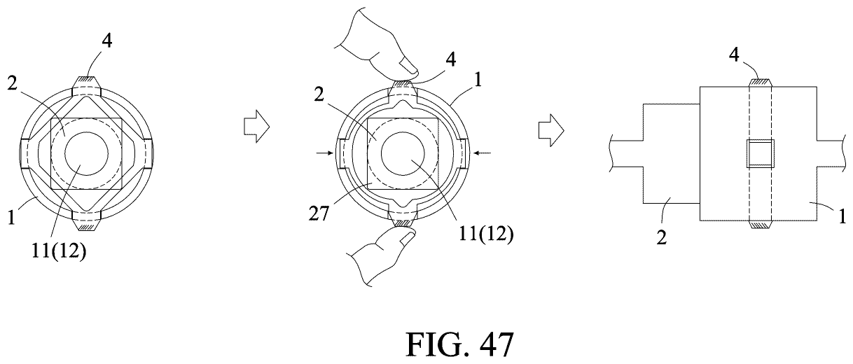

Referring to FIG. 47, in addition to the embodiment above, in one embodiment of the present disclosure, the differences from the embodiments above are that, the engaging body 4 can be disposed at the first body 1 or the second body 2 according to requirements, for the engaging body 4 to engage the first body or the second body 2, and the engaging body 4 is an annular engaging body or an engaging body having a variable form for the engaging body 4 to be pressed and deformed, so as to separate or couple the first body 1 and the second body 2.

In addition to the embodiment above, in one embodiment of the present disclosure, the engaging body 4 is a plastic engaging body, a metal engaging body, an elastic engaging body, a flexible engaging body, a structure having a variable form and capable of deforming from a sloped surface or a curved surface to a convex surface, a curved surface or a circular surface or capable of departing from the engagement receiving portion 27, so as to achieve effects of easy couple and separation of the first body 1 and the second body 2.

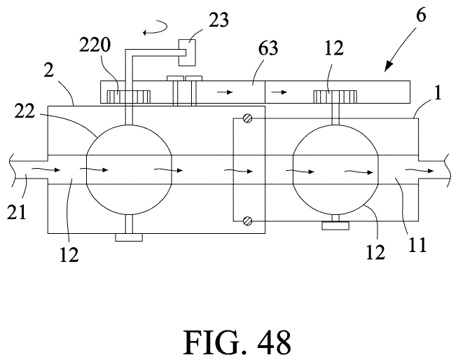

Referring to FIG. 48, in addition to the embodiment above, in one embodiment of the present disclosure, the differences from the embodiments above are that, the first block body 12 is provided with a first dentate portion 121, the second block 22 is provided with a second dentate portion 221, the object 6 is provided with a corresponding dentate portion 63, and the corresponding dentate portion 63 drives the first dentate portion 121 and the second dentate portion 221, so as to drive the first block body 12 and the second block body 22 to respectively open the first flow path 11 and the second flow path 21.

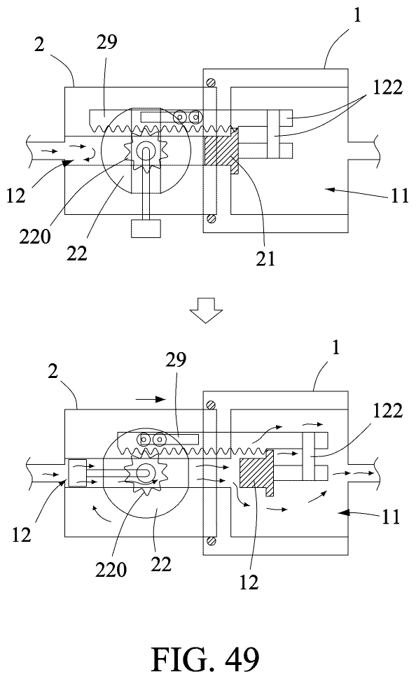

Referring to FIG. 49, in addition to the embodiment above, in one embodiment of the present disclosure, the differences from the embodiments above are that, the second block body 22 is a rotating body and is provided with a second dentate portion 221, the first block body 12 is provided with a linked portion 122 (the linked portion 122 can have a movement space), the second body 2 is provided with a corresponding dentate portion 29 for driving the first block body 12 and the second block body 22 to open the first flow path 11 and the second flow path 21, for the first block body 12 or the second block body 22 to be securely located at a position at which a flow path is open or at a position at which a flow path is closed.

In addition to the embodiments above, in one embodiment of the present disclosure, the first positioning portion 12 and the second positioning portion 22 can be rotating bodies or non-rotating bodies, and the corresponding dentate portion 29 or the linked portion 122 can also be disposed at the first body 1, the second body 2 or the object 6, thereby enabling the present disclosure to better meet actual application requirements.

Moreover, the corresponding dentate portion 29 can also be driven by the first dentate portion 121 or the second dentate portion 221 so as to drive the linked portion 122 (the first dentate portion 121 or the second dentate portion 221), thereby enabling the present disclosure to better meet actual application requirements.

In addition to the embodiments above, in one embodiment of the present disclosure, the first dentate portion 121, the second dentate portion 221, the corresponding dentate portion 29 and the linked portion 122 can drive each other, thereby enabling the present disclosure to better meet actual application requirements.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A communicating structure, comprising:
a first body, comprising a first flow path which is movably provided with a first block body; and
a second body, comprising a second flow path which is movably provided with a second block body.

2. The communicating structure according to claim 1, wherein he first block body or the second block body has a stop portion, or the stop portion limits a movement position of the first block body, the second block body, a first operating portion of the first block body or a second operating portion of the second block body, or the stop portion is provided with at least one flow passage, or the flow passage is in communication with the second flow path or the first flow path, or wherein the first block body or the second block body has a torsion spring or an elastic element, or the torsion spring or the elastic element has one end press against the first body or the second body and one other end press against the first block body or the second block body, or for the first block body or the second block body that is rotatable or turnable to normally press against a position at which the first flow path or the second flow path is closed, or for the first block body or the second block body to normally press against a position at which the first flow path or the second flow path is open.

3. The communicating structure according to claim 1, wherein the first body, the first flow path, the first block body, the second body, the second flow path or the second block body is provided with a fluid block body or a fluid absorption body, or wherein the first block body, the second block body, the fluid block body or the fluid absorption body is a corresponding structure, for the first block body and the second block body to come into contact with, resist against or elastically resist against each other in between, or wherein the fluid block body or the fluid absorption body is an O-ring, a ring, an elastic body, foam, a cotton body, a suction fluid valve, a sponge body, a siphon, a foam body, a fiber body, a suction cotton body, a recyclable material body, a decomposable material body, a glue body, a buffer body or a fluid absorbing object, or wherein the first block body or the second block body has a fluid absorption body, or a push position of the first block body or the second block body has a fluid absorption body, or push positions of the first block body and the second block body have a fluid absorption body, or wherein the first block body or the second block body is installed with, interferes with, has, in contact with or is adjacent to a fluid block body or a fluid absorption body, or wherein the first block body or the second block body is a fluid block body or a fluid absorption body, or wherein a part of a fluid block body or a fluid absorption body corresponding to any object is an arc, a slope, a step, a plane, a curve, a recess, a protrusion or a structure capable of fitting with, interfering with or getting close to any object, or wherein a fluid block body or a fluid absorption body is capable of absorbing a fluid of the first block body or the second block body or between two block bodies, or the first block body, the second block body, the first body or the second body has a fluid absorption body, wherein a position of the fluid absorption body does not come into contact with a fluid when the fluid flows, for the fluid absorption body to absorb a fluid not closed by the first block body or the second block body, or a fluid residing between the first block body, the second block body or the first body or the second body, when one of the first block body and the second block body is closed, when both of the first block body and the second block body are closed, or when the first body and the second body are separated.

4. The communicating structure according to claim 1, wherein the first body or the second body is provided with an engaging body, or the engaging body engages the first body or the second body, or the engaging body is an elastic engaging body, a bead, a plastic fastener, a metal engaging body, a labor-saving engaging body, a spring engaging body, or a lever engaging body, or the engaging body engages the first body or the second body, or wherein the first body or the second body is installed at an object, the object drives or is linked with the first body or the second body to insert into, assemble into, insert into in a blind manner, or couple with in a blind manner the second body or the first body, or wherein the object is a printed circuit board, a heat dissipater, a casing, an integrated circuit (IC), a computer, an electrical conductor, a metal body, a non-metal body or a plastic body, or wherein the first body or the second body has an operating portion, or the operating portion has an engaging portion for engagingly connecting the first body or the second body, or the engaging portion has a pull portion, or for the pull portion to be pressed or pulled to open and close the engaging portion, or the engaging portion has an elastic element for the engaging portion to perform elastic engagement connection.

5. The communicating structure according to claim 1, wherein the first body or the second body is provided with an elastic element, two ends of the elastic element respectively press the first body and the first block body, or two ends of the elastic element respectively press against the second body and the second block body, or the second body is provided with an elastic element, two ends of the elastic element respectively press against the second body and the second block body, or an elastic force of the elastic element is less than a dynamic force or a thrust force of a fluid flowing to the second flow path, or an elastic force of the elastic element is less than a dynamic force or a thrust force of a fluid flowing from the first body to the second flow path, or an elastic force of the elastic element is less than a dynamic force or a thrust force of a fluid flowing from the first body to the second body to push the second block body to open the second flow path, or wherein the second body has a limiting force or a limiting structure for limiting the second block body, or the limiting force or the limiting structure is less than a dynamic force or a thrust force of a fluid flowing from the first body to the second flow path so as to push the second block body to open the second flow path, or the limiting force or the limiting structure is an elastic force, an elastic structure, a structure capable of reciprocating motion, a force capable of reciprocating motion, a fluid force, a gas force or electrically driven force.

6. The communicating structure according to claim 1, wherein the second block body or the first block body has a discharge portion for discharging a fluid between the first body and the second body, or for discharging a fluid between the first block body and the second block body, or for discharging a fluid between the first body and the second body into the first body or the second body, or for discharging a fluid between the first block body and the second block body into the first block body or the second block body, or wherein the first body is provided with a push portion, the push portion pushes the second block body in the second body, or the push portion has a channel, and a fluid is communicated via the channel when the push portion enters the second body, or the channel is located on a lateral position of the push portion.

7. The communicating structure according to claim 1, wherein the first block body is provided with a first operating portion or the second block body is provided with a second operating portion, or the first operating portion has a first positioning portion or the second operating portion has a second positioning portion, or the first block body has a first positioning portion or the second block body has a second positioning portion, or the first body has a first positioning portion or the second body has a second positioning portion, or the first positioning portion or the second positioning portion is for positioning the first block body or the second block body at a position at which a flow path is opened or at a position at which a flow path is closed, or wherein an elastic element is further comprised, the elastic element is for the first positioning portion or the second positioning portion to be elastically engagingly connected at the first body or the second body, or for the first block body or the second block body to be limited at a position at which a flow path is opened or at a position at which a flow path is closed, or the first positioning portion or the second positioning portion is an engaging body, an engaging portion or a limiting portion.

8. The communicating structure according to claim 1, wherein the first block body is connected to a first dentate portion, the second block body is connected to a second dentate portion, the first dentate portion is turned to drive the second dentate portion to open or close two flow paths, or the first block body or the second block body is a valve, a ball valve, a lateral valve, a door valve or a valve body, or the first dentate portion or the second dentate portion is a gear or a rack, or wherein the second body or the first body is provided with at least one track, the track is for guiding or regularizing the first block body or the second block body, or the second body or the first body is provided with a guide portion for guiding the second block body or the first block body to move at the guide portion, or the guide portion has the first flow path or the second flow path.

9. The communicating structure according to claim 1, wherein the second body is provided with a resist portion, the resist portion limits a receding position of the second block body, or the resist portion is provided with at least one through hole, and the through hole is in communication with the second flow path, or the second body pushes the first block body to open the first flow path closed by a resist portion and the first block body, or for a fluid to push the second block body to open the second flow path, or wherein the second body pushes the first block body to open the first flow path closed by a resist portion and the first block body, for a fluid to push the second block body to open the second flow path, or wherein an elastic element is comprised to press against the second body and the second block body, for opening the second flow path when a force of a fluid is greater than a force of the elastic element, or the force of the fluid is reduced when the second body moves in a direction for closing the first flow path, or the flow path is closed when the force of the elastic element is greater than the force of the fluid, or the force of the fluid is reduced or the force of the fluid is stopped when the second body moves in a direction for closing the first flow path, and when the force of the elastic element is greater than the force of the fluid or when the force of the fluid is stopped, the second flow path is closed or the first flow path is closed, or the first flow path or the second flow path is simultaneously closed, or the first flow path is first closed and then the second flow path is closed, or the second flow path is first closed and then the first flow path is closed, or a direction in which the second body moves in a direction for closing the first flow path is moving toward the second body.

10. The communicating structure according to claim 1, wherein the second body pushes the first block body to open the first flow path closed by a resist portion and the first block body, the resist portion is for the second block body to move in a direction for opening the second flow path for a fluid to push the second block body to open the second path, or the second body pushes the first block body to open the first flow path closed by a resist portion and the first block body, or the resist portion pushes the second block body to open the second flow path, or wherein the first body is provided with a resist portion, and the resist portion has at least one circulation portion to communicate a fluid, or for the second body to push the first block body to open the first flow path for the fluid to flow into the second body through the circulation portion, or for the second body to push the first block body to open the first flow path and for the resist portion to push the second block body for the fluid to flow into the second body.

11. The communicating structure according to claim 1, wherein the second body has a driving portion, or the driving portion is for driving the first block body, or the driving portion is for driving the first block body to rotate or turn to open the first flow path, or wherein the driving portion is a dentate portion, a gear or a rack, or wherein the driving portion laterally or vertically drives a driving portion of the first body, or wherein the driving portion has a movement space for limiting movement, or wherein the driving portion has a limiting portion for limiting, positioning or temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion, or the first body has a driving portion, or the driving portion is for driving the second block body, or the driving portion is for driving the second block body to rotate or turn to open the second flow path, or wherein the driving portion is a dentate portion, a gear or a rack, or wherein the driving portion laterally or vertically drives a driving portion of the second body, or wherein the driving portion has a movement space for limiting movement, or wherein the driving portion has a limiting portion for limiting, positioning or temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion, or wherein the second body or the first body has a driving portion, or the driving portion is for driving the second block body and the first block body, or the driving portion is for driving the second block body or the first block body to rotate or turn to open the first flow path or the second flow path, or wherein the driving portion is a dentate portion, a gear or a rack, or wherein the driving portion drives laterally or vertically, or wherein the driving portion has a movement space for limiting movement, or wherein driving portion has a limiting portion for limiting, positioning or temporary positioning, or wherein the first body or the second body has a limiting portion for limiting, positioning or temporary positioning, or the limiting portion has an elastic element for elastically pressing against the driving portion, or the driving portion is a column, a sliding body, a support body, or a structure top-bottom engagingly connected, assembled or slidably connected at the second body or the first body, or the driving portion has an operating portion for operating the driving portion, or the second body or the first body has a driving portion, or the driving portion is for first driving one of the second block body or the first block body and then driving one of the second block body or the first block body, for the second block body or the first block body to have different opening/closing sequences, or for the first block body or the second block body to be not closed when the second block body or the first block body is closed, for a fluid to flow to the second block body or the first block body that is not closed, or for a fluid between the second block body or the first block body to flow into the first block body or the second block body that is not closed, or to close the first block body or the second block body when there is no fluid or when there is almost no fluid between the second block body or the first block body.

12. The communicating structure according to claim 1, wherein the first block body or the second block body is provided with a first flow path, a second flow path or a communicating portion, the first flow path, the second flow path or the communicating portion and another communicating portion are located at different heights, height differences, up and down positions or up and down position differences, or for a fluid to flow from a high position to a low position so that the fluid flows to a low position when the first block body or the second block body that is at a higher position is closed, or to reduce or completely block a fluid between the first block body and the second block body when both of the first block body and the second block body are closed, or wherein the second block body and the second body or the first body have a flow space in between, or for a fluid located between the first block body and the second block body to flow from the flow space to or flow into the second body when the second body is closed, or for a fluid located between the first body and the second body to flow from the flow space to or flow into the second body when the second body is closed, or the second block body has a fluid block body, or the second block body has a fluid block body at a position capable of delaying or later closing the flow space, or for closing inflow or outflow of a fluid in the flow space after the fluid passes through the flow space, or for closing the flow space, or for reducing or decreasing a fluid between the first block body and the second block body, or for reducing or decreasing a fluid between the first body and the second body.
